(19) United States
(12) Patent Application Publication
(10) Pub. No.: US 2020/0208024 A1
(43) Pub. Date: Jul. 2, 2020

(54) ADHESIVE COMPOSITION AND METHODS OF FORMING THE SAME

(71) Applicant: SAINT-GOBAIN PERFORMANCE PLASTICS CORPORATION, Solon, OH (US)

(72) Inventors: Nicky CHAN, Hudson, MA (US); Kapsoo CHEON, Marlborough, MA (US); Olivia GADY, Saint Martin De Jussac (FR); Yubo CUI, Shrewsbury, MA (US); Choung-Houng LAI, Acton, MA (US); James N. GORDON, Waban, MA (US)

(21) Appl. No.: 16/720,138

(22) Filed: Dec. 19, 2019

Related U.S. Application Data
(60) Provisional application No. 62/786,044, filed on Dec. 28, 2018.

(51) Int. Cl. C09J 133/08; C09J 133/10; C09J 7/38; C08F 220/18; C08F 220/06; C08F 220/56; C08F 220/20; C08F 226/10; C08F 236/20

(52) U.S. Cl. CPC C09J 133/08; C09J 133/10; C09J 7/38; C08F 220/1808; C08F 220/06; C08F 236/22; C08F 220/1811; C08F 220/20; C08F 226/10; C08F 236/20; C09J 2203/30; C08F 220/56

(57) ABSTRACT

An adhesive composition may include at least about 2 wt. % and not greater than 49 wt. % of a (meth)acrylic based polymeric component A for a total weight of the adhesive composition, at least about 51 wt. % of a (meth)acrylic based polymeric component B for a total weight of the adhesive composition; and at least about 0.1 wt. % and not greater than about 30 wt. % of a tackifier component for a total weight of the adhesive composition. The (meth)acrylic based polymeric component A may be acidic and may have a glass transition temperature (Tg) of at least about 40° C. The (meth)acrylic based polymeric component B may be basic and may have a glass transition temperature (Tg) of not greater than about 20° C.

### CROSS-REFERENCE TO RELATED APPLICATION(S)

This application claims priority under 35 U.S.C. § 119(e) to U.S. Provisional Patent Application No. 62/786,044, entitled ADHESIVE COMPOSITION AND METHODS OF FORMING THE SAME,” by Nicky CHAN et al., filed Dec. 28, 2018, which is assigned to the current assignee hereof and is incorporated herein by reference in its entirety.

### FIELD OF THE DISCLOSURE

The present disclosure relates to an adhesive composition and methods of forming the same. The present disclosure further relates to a foam tape that includes an adhesive composition and methods of forming the same.

### BACKGROUND

Pressure sensitive adhesives are used to attach a variety of substrates in a number of industrial and consumer markets. Depending on specific applications, pressure sensitive adhesives may be designed either as one single layer or as multiple layers. The substrates can be of similar nature, or of very different nature. The substrates of very different nature tend to be more challenging to be attached, especially when the substrate on one side is made of thermoplastic olefins including polypropylene and polypropylene/ethylene propylene diene terpolymer. Typically, pressure sensitive adhesives designed for these thermoplastic materials tend to lack sufficient cohesive strength as well as long term stability. These issues become more critical in those applications where the pressure sensitive adhesives are required to possess both high adhesion and high cohesion, and are expected to be exposed to elements in nature for many years. Therefore, there is a strong need to develop pressure sensitive adhesive compositions that retain high overall performance on thermoplastic olefins even after years of exposure.

### SUMMARY

According to a first aspect, an adhesive composition may include at least about 2 wt. % and not greater than 49 wt. % of a (meth)acrylic based polymeric component A for a total weight of the adhesive composition, at least about 51 wt. % of a (meth)acrylic based polymeric component B for a total weight of the adhesive composition; and at least about 0.1 wt. % and not greater than about 30 wt. % of a tackifier component for a total weight of the adhesive composition. The (meth)acrylic based polymeric component A may be acidic and may have a glass transition temperature (Tg) of at least about 40° C. The (meth)acrylic based polymeric component B may be basic and may have a glass transition temperature (Tg) of not greater than about 20° C.

According to another aspect, an adhesive composition may include at least about 2 wt. % and not greater than 49 wt. % of a (meth)acrylic based polymeric component A for a total weight of the adhesive composition, at least about 51 wt. % of a (meth)acrylic based polymeric component B for a total weight of the adhesive composition, and at least about 0.1 wt. % and not greater than about 30 wt. % of a tackifier component for a total weight of the adhesive composition. The (meth)acrylic based polymeric component A may further be a reaction product of polymerizable material that may include at least about 40 wt. % and not greater than about 99 wt. % of a monomer component a1 for a total weight of the (meth)acrylic based polymeric component A and at least about 0.1 wt. % and not greater than about 20 wt. % of a monomer component a2 for a total weight of the (meth)acrylic based polymeric component A. The monomer component a1 may be an ethylenically unsaturated monomer and the monomer component a2 may be an acidic monomer having an acidic group and an ethylenically unsaturated group. The (meth)acrylic based polymeric component B may be basic.

According to yet another aspect, an adhesive composition may include at least about 2 wt. % and not greater than 49 wt. % of a (meth)acrylic based polymeric component A for a total weight of the adhesive composition, at least about 51 wt. % of a (meth)acrylic based polymeric component B for a total weight of the adhesive composition, and at least about 0.1 wt. % and not greater than about 30 wt. % of a tackifier component for a total weight of the adhesive composition. The (meth)acrylic based polymeric component A may further be a reaction product of polymerizable material that may include at least about 40 wt. % and not greater than about 99 wt. % of a monomer component a1 for a total weight of the (meth)acrylic based polymeric component A and at least about 0.1 wt. % and not greater than about 20 wt. % of a monomer component a2 for a total weight of the (meth)acrylic based polymeric component A. The monomer component a1 may be an ethylenically unsaturated monomer and the monomer component a2 may be an acidic monomer having an acidic group and an ethylenically unsaturated group. The (meth)acrylic based polymeric component B may further be a reaction product of polymerizable material that may include at least about 40 wt. % and not greater than about 99 wt. % of a monomer component b1 for a total weight of the (meth)acrylic based polymeric component B and at least about 1 wt. % and not greater than about 60 wt. % of a monomer component b2 for a total weight of the (meth)acrylic based polymeric component B. The monomer component b1 may be a C1-C24 acrylic ester, and the monomer component b2 may be an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

According to still another aspect, a method of forming an adhesive composition may include providing a pre-adhesive mixture, mixing the pre-adhesive mixture, and polymerizing the pre-adhesive mixture to form the adhesive composition. The pre-adhesive mixture may include a pre-adhesive (meth)acrylic based polymeric component A, a pre-adhesive (meth)acrylic based polymeric component B, a pre-adhesive tackifier component. The pre-adhesive (meth)acrylic based polymeric component A may be fully polymerized prior to being provided for the pre-adhesive mixture. The pre-adhesive (meth)acrylic based polymeric component B may be unpolymerized prior to being provided for the pre-adhesive mixture.

According to still another aspect, a monolayer foam tape may include a foam core comprising hollow microspheres within an adhesive composition. The adhesive composition may include at least about 2 wt. % and not greater than 49 wt. % of a (meth)acrylic based polymeric component A for a total weight of the adhesive composition, at least about 51 wt. % of a (meth)acrylic based polymeric component B for a total weight of the adhesive composition; and at least about 0.1 wt. % and not greater than about 30 wt. % of a tackifier component for a total weight of the adhesive composition. The (meth)acrylic based polymeric component A may be acidic and may have a glass transition temperature (Tg) of at least about 40° C. The (meth)acrylic based polymeric component B may be basic and may have a glass transition temperature (Tg) of not greater than about 20° C.

According to yet another aspect, a monolayer foam tape may include a foam core comprising hollow microspheres within an adhesive composition. The adhesive composition may include at least about 2 wt. % and not greater than 49 wt. % of a (meth)acrylic based polymeric component A for a total weight of the adhesive composition, at least about 51 wt. % of a (meth)acrylic based polymeric component B for a total weight of the adhesive composition, and at least about 0.1 wt. % and not greater than about 30 wt. % of a tackifier component for a total weight of the adhesive composition. The (meth)acrylic based polymeric component A may further be a reaction product of polymerizable material that may include at least about 40 wt. % and not greater than about 99 wt. % of a monomer component a1 for a total weight of the (meth)acrylic based polymeric component A and at least about 0.1 wt. % and not greater than about 20 wt. % of a monomer component a2 for a total weight of the (meth)acrylic based polymeric component A. The monomer component a1 may be an ethylenically unsaturated monomer and the monomer component a2 may be an acidic monomer having an acidic group and an ethylenically unsaturated group. The (meth)acrylic based polymeric component B may be basic.

According to another aspect, a monolayer foam tape may include a foam core comprising hollow microspheres within an adhesive composition. The adhesive composition may include at least about 2 wt. % and not greater than 49 wt. % of a (meth)acrylic based polymeric component A for a total weight of the adhesive composition, at least about 51 wt. % of a (meth)acrylic based polymeric component B for a total weight of the adhesive composition, and at least about 0.1 wt. % and not greater than about 30 wt. % of a tackifier component for a total weight of the adhesive composition. The (meth)acrylic based polymeric component A may further be a reaction product of polymerizable material that may include at least about 40 wt. % and not greater than about 99 wt. % of a monomer component a1 for a total weight of the (meth)acrylic based polymeric component A and at least about 0.1 wt. % and not greater than about 20 wt. % of a monomer component a2 for a total weight of the (meth)acrylic based polymeric component A. The monomer component a1 may be an ethylenically unsaturated monomer and the monomer component a2 may be an acidic monomer having an acidic group and an ethylenically unsaturated group. The (meth)acrylic based polymeric component B may further be a reaction product of polymerizable material that may include at least about 40 wt. % and not greater than about 99 wt. % of a monomer component b1 for a total weight of the (meth)acrylic based polymeric component B and at least about 1 wt. % and not greater than about 60 wt. % of a monomer component b2 for a total weight of the (meth)acrylic based polymeric component B. The monomer component b1 may be a C1-C24 acrylic ester, and the monomer component b2 may be an ethylenically unsaturated functional monomer selected from hydroxyl containing (meth)acrylic monomer, a nitrogen-containing monomer having a primary, secondary or tertiary amino group, or a nitrogen-containing monomer having a primary secondary, or tertiary amido group.

According to still another aspect, a foam tape may include a foam core and a first adhesive layer overlying a first surface of the foam core. The foam core may include hollow microspheres within a foam material. The first adhesive layer may include a first adhesive composition. The first adhesive composition may include at least about 2 wt. % and not greater than 49 wt. % of a first (meth)acrylic based polymeric component A for a total weight of the first adhesive composition, at least about 51 wt. % of a first (meth)acrylic based polymeric component B for a total weight of the first adhesive composition; and at least about 0.1 wt. % and not greater than about 30 wt. % of a first tackifier component for a total weight of the first adhesive composition. The first (meth)acrylic based polymeric component A may be acidic and may have a glass transition temperature (Tg) of at least about 40° C. The first (meth)acrylic based polymeric component B may be basic and may have a glass transition temperature (Tg) of not greater than about 20° C.

According to yet another aspect, a foam tape may include a foam core and a first adhesive layer overlying a first surface of the foam core. The foam core may include hollow microspheres within a foam material. The first adhesive layer may include a first adhesive composition. The first adhesive composition may include at least about 2 wt. % and not greater than 49 wt. % of a first (meth)acrylic based polymeric component A for a total weight of the first adhesive composition, at least about 51 wt. % of a first (meth)acrylic based polymeric component B for a total weight of the first adhesive composition, and at least about 0.1 wt. % and not greater than about 30 wt. % of a first tackifier component for a total weight of the first adhesive composition. The first (meth)acrylic based polymeric component A may further be a reaction product of polymerizable material that may include at least about 40 wt. % and not greater than about 99 wt. % of a first monomer component a1 for a total weight of the first (meth)acrylic based polymeric component A and at least about 0.1 wt. % and not greater than about 20 wt. % of a first monomer component a2 for a total weight of the first (meth)acrylic based polymeric component A. The first monomer component a1 may be an ethylenically unsaturated monomer and the first monomer component a2 may be an acidic monomer having an acidic group and an ethylenically unsaturated group. The first (meth)acrylic based polymeric component B may be basic.

According to another aspect, a foam tape may include a foam core and a first adhesive layer overlying a first surface of the foam core. The foam core may include hollow microspheres within a foam material. The first adhesive layer may include a first adhesive composition. The first adhesive composition may include at least about 2 wt. % and not greater than 49 wt. % of a first (meth)acrylic based polymeric component A for a total weight of the first adhesive composition, at least about 51 wt. % of a first (meth)acrylic based polymeric component B for a total weight of the first adhesive composition, and at least about 0.1 wt. % and not greater than about 30 wt. % of a first tackifier component for a total weight of the first adhesive composition. The first (meth)acrylic based polymeric component A may further be a reaction product of polymerizable material that may include at least about 40 wt. % and not greater than about 99 wt. % of a first monomer component a1 for a total weight of the first (meth)acrylic based polymeric component A and at least about 0.1 wt. % and not greater than about 20 wt. % of a first monomer component a2 for a total weight of the first (meth)acrylic based polymeric component A. The first monomer component a1 may be an ethylenically unsaturated monomer and the first monomer component a2 may be an acidic monomer having an acidic group and an ethylenically unsaturated group. The first (meth)acrylic based polymeric component B may further be a reaction product of polymerizable material that may include at least about 40 wt. % and not greater than about 99 wt. % of a first monomer component b1 for a total weight of the first (meth)acrylic based polymeric component B and at least about 1 wt. % and not greater than about 60 wt. % of a first monomer component b2 for a total weight of the first (meth)acrylic based polymeric component B. The first monomer component b1 may be a C1-C24 acrylic ester, and the first monomer component b2 may be an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### BRIEF DESCRIPTION OF THE DRAWINGS

Embodiments are illustrated by way of example and are not limited to the accompanying figures.

FIG. 1 includes a diagram showing an adhesive composition forming method according to embodiments described herein;

FIG. 2 includes an illustration showing the configuration of a monolayer foam tape formed according to embodiments described herein;

FIG. 3 includes an illustration showing the configuration of a foam tape having a single adhesive layer formed according to embodiments described herein; and

FIG. 4 includes an illustration showing the configuration of a foam tape having two adhesive layers formed according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B is true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to an adhesive composition and methods of forming an adhesive composition, and more particularly to an adhesive composition having superior adhesion properties and methods of forming the same.

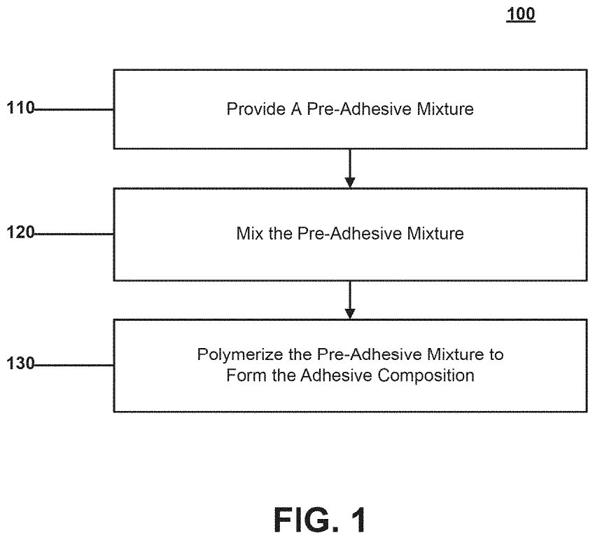

For purposes of illustration, FIG. 1 includes a diagram showing an adhesive composition forming method 100 according to particular embodiments described herein. The adhesive composition forming method 100 may include a first step 110 of providing a pre-adhesive mixture, a second step 120 of mixing the pre-adhesive mixture, and a third step 130 of polymerizing the pre-adhesive mixture to form the adhesive composition.

Referring to the first step 110, according to certain embodiments, the pre-adhesive mixture may include a pre-adhesive (meth)acrylic based polymeric component A that is fully polymerized prior to being added to the pre-adhesive mixture, a pre-adhesive (meth)acrylic based polymeric component B that is unpolymerized prior to being added to the pre-adhesive mixture, and a pre-adhesive tackifier component.

According to particular embodiments, the pre-adhesive (meth)acrylic based polymeric component A may be referred as a high glass transition temperature (Tg) pre-adhesive (meth)acrylic based polymeric component. According to still other embodiments, the pre-adhesive (meth)acrylic based polymeric component A may have a particular glass transition temperature (Tg) as estimated by the Fox Equation, based on the Tgs of the homopolymer of constituent monomers and the weight percent thereof. For example, the pre-adhesive (meth)acrylic based polymeric component A may have a glass transition temperature (Tg) of at least about 40° C., such as, at least about 45° C. or at least about 50° C. or at least about 55° C. or at least about 60° C. or at least about 65° C. or at least about 70° C. or at least about 75° C. or even at least about 80° C. It will be appreciated that the glass transition temperature of the pre-adhesive (meth)acrylic based polymeric component A may be within a range between any of the values noted above. It will be further appreciated that the glass transition temperature of the pre-adhesive (meth)acrylic based polymeric component A may be any value between any of the values noted above.

According to still other embodiments, the pre-adhesive (meth)acrylic based polymeric component A may have a particular molecular weight. For example, the pre-adhesive (meth)acrylic based polymeric component A may have a molecular weight of at least about 5,000 g/mol, such as, at least about 7,500 g/mol or at least about 10,000 g/mol or at least about 12,500 g/mol or at least about 15,000 g/mol or at least about 17,500 g/mol or at least about 20,000 g/mol or at least about 25,000 g/mol or at least about 27,500 g/mol or at least about 30,000 g/mol or at least about 32,500 g/mol or at least about 35,000 g/mol or at least about 37,500 g/mol or at least about 40,000 g/mol or at least about 42,500 g/mol or even at least about 45,000 g/mol According to still other embodiments, the pre-adhesive (meth)acrylic based polymeric component A may have a molecular weight of not greater than about 200,000 g/mol, such as, not greater than about 150,000 g/mol or even not greater than about 100,000 g/mol. It will be appreciated that the molecular weight of the pre-adhesive (meth)acrylic based polymeric component A may be within a range between any of the minimum and maximum values noted above. It will be further appreciated that the molecular weight of the pre-adhesive (meth)acrylic based polymeric component A may be any value between any of the minimum and maximum values noted above.

According to still other embodiments, the pre-adhesive (meth)acrylic based polymeric component A may be acidic. For purposes of embodiments described herein, the term “acidic” may be defined as containing an acid functional monomer in polymeric component A. According to certain embodiments, the overall level of acidic monomer in component A may be greater than about 1% by weight, or greater than about 3% by weight, or greater than 5% by weight, or greater than about 7% by weight.

According to particular embodiments, the pre-adhesive (meth)acrylic based polymeric component B may be referred as a low glass transition temperature (Tg) pre-adhesive (meth)acrylic based polymeric component. According to still other embodiments, the pre-adhesive (meth)acrylic based polymeric component B may have a particular glass transition temperature (Tg) as estimated by the Fox Equation, based on the Tgs of the homopolymer of constituent monomers and the weight percent thereof. For example, the pre-adhesive (meth)acrylic based polymeric component B may have a glass transition temperature (Tg) of not greater than about 20° C., such as, not greater than about 15° C. or not greater than about 10° C. or not greater than about 5° C. or even not greater than about 0° C. It will be appreciated that the glass transition temperature of the pre-adhesive (meth)acrylic based polymeric component B may be within a range between any of the values noted above. It will be further appreciated that the glass transition temperature of the pre-adhesive (meth)acrylic based polymeric component B may be any value between any of the values noted above.

According to still other embodiments, the pre-adhesive (meth)acrylic based polymeric component B may have a particular molecular weight. For example, the pre-adhesive (meth)acrylic based polymeric component A may have a molecular weight of at least about 5,000 g/mol, such as, at least about 7,500 g/mol or at least about 10,000 g/mol or at least about 12,500 g/mol or at least about 15,000 g/mol or at least about 17,500 g/mol or at least about 20,000 g/mol or at least about 25,000 g/mol or at least about 27,500 g/mol or at least about 30,000 g/mol or at least about 32,500 g/mol or at least about 35,000 g/mol or at least about 37,500 g/mol or at least about 40,000 g/mol or at least about 42,500 g/mol or even at least about 45,000 g/mol. According to still other embodiments, the pre-adhesive (meth)acrylic based polymeric component A may have a molecular weigh of not greater than about 200,000 g/mol, such as, not greater than about 150,000 g/mol or even not greater than about 100,000 g/mol. It will be appreciated that the molecular weight of the pre-adhesive (meth)acrylic based polymeric component B may be within a range between any of the minimum and maximum values noted above. It will be further appreciated that the molecular weight of the pre-adhesive (meth)acrylic based polymeric component B may be any value between any of the minimum and maximum values noted above.

According to still other embodiments, the (meth)acrylic based polymeric component B may be basic. For purposes of embodiments described herein, the term “basic” may be defined as containing a basic monomer in polymeric component B. According to some embodiments, the basic monomer may be a nitrogen containing monomer having a primary, secondary or tertiary amino group, or the basic monomer may be a nitrogen containing monomer having a primary, secondary, or tertiary amido group. According to some embodiments, the overall level of basic monomer in component B may be greater than about 1% by weight, or greater than about 3% by weight, or greater than 5% by weight, or greater than about 7% by weight, or greater than about 9% by weight, or greater than about 11% by weight, or greater than about 13% by weight.

According to yet other embodiments, the pre-adhesive mixture may include a particular content of the pre-adhesive (meth)acrylic based polymeric component A. For example, the content of the pre-adhesive (meth)acrylic based polymeric component A in the pre-adhesive mixture may be at least about 2.0 wt. % for a total weight of the pre-adhesive mixture, such as, at least about 2.5 wt. % or at least about 3.0 wt. % or at least about or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or at least about 7.0 wt. % or at least about 7.5 wt. % or at least about 8.5 wt. % or at least about 9.0 wt. % or at least about 9.5 wt. % or even at least about 10.0 wt. %. According to still other embodiments, the content of the pre-adhesive (meth)acrylic based polymeric component A in the pre-adhesive mixture may be not greater than about 49.0 wt. % for a total weight of the pre-adhesive mixture, such as, not greater than about 47.0 wt. % or not greater than about 45.0 wt. % or not greater than about 42.0 wt. % or not greater than about 40.0 wt. % or not greater than about 37.0 wt. % or not greater than about 35.0 wt. % or not greater than about 32.0 wt. % or not greater than about 30.0 wt. % or not greater than about 27.0 wt. % or not greater than about 25.0 wt. % or not greater than about 22.0 wt. % or not greater than about 20.0 wt. % or not greater than about 17.0 wt. % or not greater than about 15.0 wt. % or even not greater than about 12.0 wt. %. It will be appreciated that the content of the pre-adhesive (meth)acrylic based polymeric component A in the pre-adhesive mixture may be within a range between any of the minimum and maximum values noted above. It will be further appreciated that the content of the pre-adhesive (meth)acrylic based polymeric component A in the pre-adhesive mixture may be any value between any of the minimum and maximum values noted above.

According to still other embodiments, the pre-adhesive (meth)acrylic based polymeric component A may include a pre-adhesive monomer component a1 and a pre-adhesive monomer component a2.

According to certain embodiments, the pre-adhesive monomer component a1 may be an ethylenically unsaturated monomer. According to still other embodiments, the pre-adhesive monomer component a1 may include, but is not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl acrylate, cyclohexyl methacrylate, isobornyl acrylate, isobornyl methacrylate, benzyl methacrylate, 3,3,5 trimethylcyclohexyl acrylate, propyl methacrylate, adamantyl acrylate, adamantly methacrylate, dicyclopentanyl acrylate, dicyclopentanyl methacrylate, norbornyl acrylate, styrene, alpha-methyl styrene, or mixtures thereof.

According to still other embodiments, the pre-adhesive monomer component a2 may be an acidic monomer having an acidic group and an ethylenically unsaturated group. According to yet other embodiments, the pre-adhesive monomer component a2 may be an acid containing (meth)acrylic monomer. According to still other embodiments, monomer component a2 may include an acidic monomer selected from, but is not limited to, an acrylic acid, methacrylic acid, itaconic acid, fumaric acid, crotonic acid, citraconic acid, maleic acid, oleic acid, β-carboxyethyl(meth)acrylate, 2-sulfoethyl methacrylate, styrene sulfonic acid, 2-acrylamido-2-methylpropanesulfonic acid, vinylphosphonic acid, or mixtures thereof.

According to still other embodiments, the pre-adhesive (meth)acrylic based polymeric component A may include a particular content of the pre-adhesive monomer component a1. For example, the content of the pre-adhesive monomer component a1 in the pre-adhesive (meth)acrylic based polymeric component A may be at least about 40 wt. % for a total weight of the pre-adhesive (meth)acrylic based polymeric component A, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the pre-adhesive monomer component a1 in the pre-adhesive (meth)acrylic based polymeric component A may be not greater than about 99 wt. % for a total weight of the pre-adhesive (meth)acrylic based polymeric component A, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the pre-adhesive monomer component a1 in the pre-adhesive (meth)acrylic based polymeric component A may be within a range between any of the minimum and maximum values noted above. It will be further appreciated that the content of the content of the pre-adhesive monomer component a1 in the pre-adhesive (meth)acrylic based polymeric component A may be any value between any of the minimum and maximum values noted above.

According to still other embodiments, the pre-adhesive (meth)acrylic based polymeric component A may include a particular content of the pre-adhesive monomer component a2. For example, the content of the pre-adhesive monomer component a2 in the pre-adhesive (meth)acrylic based polymeric component A may be at least about 0.1 wt. % for a total weight of the pre-adhesive (meth)acrylic based polymeric component A, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the pre-adhesive monomer component a2 in the pre-adhesive (meth)acrylic based polymeric component A may be not greater than about 20.0 wt. % for a total weight of the pre-adhesive (meth)acrylic based polymeric component A, such as, not greater than about 19.5 wt. % or not greater than about 19.0 wt. % or not greater than about 18.5 wt. % or not greater than about 18.0 wt. % or not greater than about 17.5 wt. % or not greater than about 17.0 wt. % or not greater than about 16.5 wt. % or not greater than about 16.0 wt. % or not greater than about 15.5 wt. % or not greater than about 15.0 wt. % or not greater than about 14.5 wt. % or not greater than about 14.0 wt. % or not greater than about 13.5 wt. % or not greater than about 13.0 wt. % or not greater than about 12.5 wt. % or not greater than about 12.0 wt. %. It will be appreciated that the content of the pre-adhesive monomer component a2 in the pre-adhesive (meth)acrylic based polymeric component A may be within a range between any of the minimum and maximum values noted above. It will be further appreciated that the content of the content of the pre-adhesive monomer component a2 in the pre-adhesive (meth)acrylic based polymeric component A may be any value between any of the minimum and maximum values noted above.

According to still other embodiments, the pre-adhesive (meth)acrylic based polymeric component A may further include a pre-adhesive monomer component a3. According to particular embodiments, the pre-adhesive monomer component a3 may be different than both the pre-adhesive monomer component a1 and the pre-adhesive monomer component a2.

According to certain embodiments, the pre-adhesive monomer component a3 may be an ethylenically unsaturated monomer. According to still other embodiments, the pre-adhesive monomer component a3 may include an ethylenically unsaturated functional monomer selected from hydroxyl containing (meth)acrylic ester or acrylamide.

According to still other embodiments, the pre-adhesive (meth)acrylic based polymeric component A may include a particular content of the pre-adhesive monomer component a3. For example, the content of the pre-adhesive monomer component a3 in the pre-adhesive (meth)acrylic based polymeric component A may be at least about 0.1 wt. % for a total weight of the pre-adhesive (meth)acrylic based polymeric component A, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the pre-adhesive monomer component a3 in the pre-adhesive (meth)acrylic based polymeric component A may be not greater than about 60 wt. % for a total weight of the pre-adhesive (meth)acrylic based polymeric component A, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the pre-adhesive monomer component a3 in the pre-adhesive (meth)acrylic based polymeric component A may be within a range between any of the minimum and maximum values noted above. It will be further appreciated that the content of the content of the pre-adhesive monomer component a3 in the pre-adhesive (meth)acrylic based polymeric component A may be any value between any of the minimum and maximum values noted above.

According to yet other embodiments, the pre-adhesive mixture may include a particular content of the pre-adhesive (meth)acrylic based polymeric component B. For example, the content of the pre-adhesive (meth)acrylic based polymeric component B in the pre-adhesive mixture may be at least about 51 wt. % for a total weight of the pre-adhesive mixture, such as, at least about 53 wt. % or at least about 55 wt. % or at least about or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to still other embodiments, the content of the pre-adhesive (meth)acrylic based polymeric component B in the pre-adhesive mixture may be not greater than about 98 wt. % for a total weight of the pre-adhesive mixture, such as, not greater than about 95 wt. % or not greater than about 92 wt. % or not greater than about 90 wt. % or not greater than about 87 wt. % or not greater than about 85 wt. % or not greater than about 82 wt. % or even not greater than about 80 wt. %. It will be appreciated that the content of the pre-adhesive (meth)acrylic based polymeric component B in the pre-adhesive mixture may be within a range between any of the minimum and maximum values noted above. It will be further appreciated that the content of the pre-adhesive (meth)acrylic based polymeric component B in the pre-adhesive mixture may be any value between any of the minimum and maximum values noted above.

According to still other embodiments, the pre-adhesive (meth)acrylic based polymeric component B may include a pre-adhesive monomer component b1 and a pre-adhesive monomer component b2.

According to certain embodiments, the pre-adhesive monomer component b1 may be a C1-C24 acrylic ester. According to still other embodiments, an alkyl groups of the pre-adhesive monomer component b1 can be straight-chained, branched with one or more branching sites, or cyclic. According to yet other embodiments, the alkyl groups may include, but are not limited to, those selected from methyl, ethyl, propyl, isopropyl, butyl, isobutyl, pentyl, 2-pentyl, hexyl, heptyl, octyl, isooctyl, 2-ethylhexyl, tert-octyl, nonyl, decyl, 2-propylheptyl, undecyl, tridecyl acrylate, (2-isopropyl-5-methyl)hexyl, tetradecyl, hexadecyl, octadecyl, branched alkyl group having 16 to 22 C atoms and including at least two branching sites, phenyl, benzyl, cyclohexyl, isobornyl, adamantyl, 3,3,5 trimethylcyclohexyl, norbornyl or mixtures thereof. According to particular embodiments, the alkyl groups may include, but are not limited to, those selected from butyl, isooctyl and 2-ethylhexyl.

According to still other embodiments, the pre-adhesive monomer component b2 may be an ethylenically unsaturated functional pre-adhesive monomer selected from the group consisting of hydroxyl containing pre-adhesive (meth)acrylic monomer and a nitrogen-containing monomer having a primary, secondary or tertiary amino group, or a nitrogen-containing monomer having a primary, secondary or tertiary amido group. According to certain embodiments, the pre-adhesive monomer component b2 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the pre-adhesive (meth)acrylic based polymeric component B may include a particular content of the pre-adhesive monomer component b 1. For example, the content of the pre-adhesive monomer component b1 in the pre-adhesive (meth)acrylic based polymeric component B may be at least about 40 wt. % for a total weight of the pre-adhesive (meth)acrylic based polymeric component B, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the pre-adhesive monomer component b1 in the pre-adhesive (meth)acrylic based polymeric component B may be not greater than about 99 wt. % for a total weight of the pre-adhesive (meth)acrylic based polymeric component B, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the pre-adhesive monomer component b1 in the pre-adhesive (meth)acrylic based polymeric component B may be within a range between any of the minimum and maximum values noted above. It will be further appreciated that the content of the content of the pre-adhesive monomer component b1 in the pre-adhesive (meth)acrylic based polymeric component B may be any value between any of the minimum and maximum values noted above.

According to still other embodiments, the pre-adhesive (meth)acrylic based polymeric component B may include a particular content of the pre-adhesive monomer component b2. For example, the content of the pre-adhesive monomer component b2 in the pre-adhesive (meth)acrylic based polymeric component B may be at least about 1 wt. % for a total weight of the pre-adhesive (meth)acrylic based polymeric component B, such as, at least about 2 wt. % or at least about 3 wt. % or at least about 4 wt. % or at least about 5 wt. % or at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to yet other embodiments, the content of the pre-adhesive monomer component b2 in the pre-adhesive (meth)acrylic based polymeric component B may be not greater than about 60 wt. % for a total weight of the pre-adhesive (meth)acrylic based polymeric component B, such as, not greater than about 57 wt. % or not greater than about 55 wt. % or not greater than about 52 wt. % or not greater than about 50 wt. % or not greater than about 47 wt. % or not greater than about 45 wt. % or not greater than about 42 wt. % or not greater than about 40 wt. % or not greater than about 37 wt. % or not greater than about 35 wt. % or not greater than about 32 wt. % or not greater than about 30 wt. % or not greater than about 27 wt. % or not greater than about 25 wt. % or not greater than about 23 wt. % or not greater than about 20 wt. %. It will be appreciated that the content of the pre-adhesive monomer component b2 in the pre-adhesive (meth)acrylic based polymeric component B may be within a range between any of the minimum and maximum values noted above. It will be further appreciated that the content of the content of the pre-adhesive monomer component b2 in the pre-adhesive (meth)acrylic based polymeric component B may be any value between any of the minimum and maximum values noted above.

According to still other embodiments, the pre-adhesive (meth)acrylic based polymeric component B may further include a pre-adhesive monomer component b3. According to particular embodiments, the pre-adhesive monomer component b3 may be different than both the pre-adhesive monomer component b1 and the pre-adhesive monomer component b2.

According to certain embodiments, the pre-adhesive monomer component b3 may be an ethylenically unsaturated monomer. According to still other embodiments, the pre-adhesive monomer component b3 may include a hydroxy-containing acrylic ester monomer having a hydroxyl group and an ethylenically unsaturated group. According to still other embodiments, the pre-adhesive monomer component b3 may include a nitrogen-containing monomer having a primary, secondary or a tertiary amino group, or a nitrogen-containing monomer having a primary, secondary, or tertiary amido group. According to still other embodiments, the pre-adhesive monomer component b3 may include a vinyl monomer. According to certain embodiments, the pre-adhesive monomer component b3 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the pre-adhesive (meth)acrylic based polymeric component B may include a particular content of the pre-adhesive monomer component b3. For example, the content of the pre-adhesive monomer component b3 in the pre-adhesive (meth)acrylic based polymeric component B may be at least about 0.1 wt. % for a total weight of the pre-adhesive (meth)acrylic based polymeric component B, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the pre-adhesive monomer component b3 in the pre-adhesive (meth)acrylic based polymeric component B may be not greater than about 60 wt. % for a total weight of the pre-adhesive (meth)acrylic based polymeric component B, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the pre-adhesive monomer component b3 in the pre-adhesive (meth)acrylic based polymeric component B may be within a range between any of the minimum and maximum values noted above. It will be further appreciated that the content of the content of the pre-adhesive monomer component b3 in the pre-adhesive (meth)acrylic based polymeric component B may be any value between any of the minimum and maximum values noted above.

According to certain embodiments, the pre-adhesive tackifier component may include C5, C9, C5/C9, dicyclopentadiene, terpene, or their hydrogenated resins, or combinations thereof.

According to yet other embodiments, the pre-adhesive mixture may include a particular content of the pre-adhesive tackifier component. For example, the content of the pre-adhesive tackifier component in the pre-adhesive mixture may be at least about at least about 0.1 wt. % for a total weight of the pre-adhesive mixture, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the pre-adhesive tackifier component in the pre-adhesive mixture may be not greater than about 30 wt. % for a total weight of the pre-adhesive mixture, such as, not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the pre-adhesive tackifier component in the pre-adhesive mixture may be within a range between any of the minimum and maximum values noted above. It will be further appreciated that the content of the pre-adhesive tackifier component in the pre-adhesive mixture may be any value between any of the minimum and maximum values noted above.

Referring now to the adhesive composition formed according to embodiments described herein, the adhesive composition may include a (meth)acrylic based polymeric component A, a (meth)acrylic based polymeric component B, and a tackifier component.

According to particular embodiments, the (meth)acrylic based polymeric component A may be referred as a high glass transition temperature (Tg) (meth)acrylic based polymeric component. According to still other embodiments, the (meth)acrylic based polymeric component A may have a particular glass transition temperature (Tg) as estimated by the Fox Equation, based on the Tgs of the homopolymer of constituent monomers and the weight percent thereof. For example, the (meth)acrylic based polymeric component A may have a glass transition temperature (Tg) of at least about 40° C., such as, at least about 45° C. or at least about 50° C. or at least about 55° C. or at least about 60° C. or at least about 65° C. or at least about 70° C. or at least about 75° C. or even at least about 80° C. It will be appreciated that the glass transition temperature of the (meth)acrylic based polymeric component A may be within a range between any of the values noted above. It will be further appreciated that the glass transition temperature of the (meth)acrylic based polymeric component A may be any value between any of the values noted above.

According to still other embodiments, the (meth)acrylic based polymeric component A may have a particular molecular weight. For example, the (meth)acrylic based polymeric component A may have a molecular weight of at least about 5,000 g/mol, such as, at least about 7,500 g/mol or at least about 10,000 g/mol or at least about 12,500 g/mol or at least about 15,000 g/mol or at least about 17,500 g/mol or at least about 20,000 g/mol or at least about 25,000 g/mol or at least about 27,500 g/mol or at least about 30,000 g/mol or at least about 32,500 g/mol or at least about 35,000 g/mol or at least about 37,500 g/mol or at least about 40,000 g/mol or at least about 42,500 g/mol or even at least about 45,000 g/mol. According to still other embodiments, the (meth)acrylic based polymeric component A may have a molecular weight of not greater than about 200,000 g/mol, such as, not greater than about 150,000 g/mol or even not greater than about 100,000 g/mol. It will be appreciated that the molecular weight of the (meth)acrylic based polymeric component B may be within a range between any of the minimum and maximum values noted above. It will be further appreciated that the molecular weight of the (meth)acrylic based polymeric component B may be any value between any of the minimum and maximum values noted above.

According to still other embodiments, the (meth)acrylic based polymeric component A may be acidic. For purposes of embodiments described herein, the term “acidic” may be defined as containing an acid functional monomer in polymeric component A. According to certain embodiments, the overall level of acidic monomer in component A may be greater than about 1% by weight, or greater than about 3% by weight, or greater than 5% by weight, or greater than about 7% by weight.

According to particular embodiments, the (meth)acrylic based polymeric component B may be referred as a low glass transition temperature (Tg) (meth)acrylic based polymeric component. According to still other embodiments, the (meth)acrylic based polymeric component B may have a particular glass transition temperature (Tg) as estimated by the Fox Equation, based on the Tgs of the homopolymer of constituent monomers and the weight percent thereof. For example, the (meth)acrylic based polymeric component B may have a glass transition temperature (Tg) of not greater than about 20° C., such as, not greater than about 15° C. or not greater than about 10° C. or not greater than about 5° C. or even not greater than about 0° C. It will be appreciated that the glass transition temperature of the (meth)acrylic based polymeric component B may be within a range between any of the values noted above. It will be further appreciated that the glass transition temperature of the (meth)acrylic based polymeric component B may be any value between any of the values noted above.

According to still other embodiments, the (meth)acrylic based polymeric component B may have a particular molecular weight. For example, the (meth)acrylic based polymeric component B may have a molecular weight of at least about 200,000 g/mol, such as, at least about 400,000 g/mol or at least about 600,000 g/mol or at least about 800,000 g/mol or at least about 1,000,000 g/mol or at least about 1,200,000 g/mol or at least about 1,400,000 g/mol or at least about 1,600,000 g/mol or at least about 1,800,000 g/mol or at least about 2,000,000 g/mol or at least about 2,200,000 g/mol or at least about 2,400,000 g/mol, or at least about 2,600,000 g/mol or at least about 2,800,000 g/mol or at least about 3,000,000 g/mol. According to still other embodiments, the (meth)acrylic based polymeric component B may have a molecular weigh of not greater than about 20,000,000 g/mol, such as, not greater than about 15,000,000 g/mol. It will be appreciated that the molecular weight of the (meth)acrylic based polymeric component B may be within a range between any of the minimum and maximum values noted above. It will be further appreciated that the molecular weight of the (meth)acrylic based polymeric component B may be any value between any of the minimum and maximum values noted above.

According to still other embodiments, the (meth)acrylic based polymeric component B may be basic. For purposes of embodiments described herein, the term “basic” may be defined as containing a basic monomer in polymeric component B. According to some embodiments, the basic monomer may be a nitrogen containing monomer having a primary, secondary or tertiary amino group, or the basic monomer may be a nitrogen containing monomer having a primary, secondary, or tertiary amido group. According to some embodiments, the overall level of basic monomer in component B may be greater than about 1% by weight, or greater than about 3% by weight, or greater than 5% by weight, or greater than about 7%, or greater than about 9%, or greater than about 11%, or greater than about 13% by weight.

According to yet other embodiments, the adhesive composition may include a particular content of the (meth)acrylic based polymeric component A. For example, the content of the (meth)acrylic based polymeric component A in the adhesive composition may be at least about 2.0 wt. % for a total weight of the adhesive composition, such as, at least about 2.5 wt. % or at least about 3.0 wt. % or at least about or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or at least about 7.0 wt. % or at least about 7.5 wt. % or at least about 8.5 wt. % or at least about 9.0 wt. % or at least about 9.5 wt. % or even at least about 10.0 wt. %. According to still other embodiments, the content of the (meth)acrylic based polymeric component A in the adhesive composition may be not greater than about 49.0 wt. % for a total weight of the adhesive composition, such as, not greater than about 47.0 wt. % or not greater than about 45.0 wt. % or not greater than about 42.0 wt. % or not greater than about 40.0 wt. % or not greater than about 37.0 wt. % or not greater than about 35.0 wt. % or not greater than about 32.0 wt. % or not greater than about 30.0 wt. % or not greater than about 27.0 wt. % or not greater than about 25.0 wt. % or not greater than about 22.0 wt. % or not greater than about 20.0 wt. % or not greater than about 17.0 wt. % or not greater than about 15.0 wt. % or even not greater than about 12.0 wt. %. It will be appreciated that the content of the (meth)acrylic based polymeric component A in the adhesive composition may be within a range between any of the minimum and maximum values noted above. It will be further appreciated that the content of the (meth)acrylic based polymeric component A in the adhesive composition may be any value between any of the minimum and maximum values noted above.

According to still other embodiments, the (meth)acrylic based polymeric component A may include a monomer component a1 and a monomer component a2.

According to certain embodiments, the monomer component a1 may be an ethylenically unsaturated monomer. According to still other embodiments, the monomer component a1 may include, but is not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl acrylate, cyclohexyl methacrylate, isobornyl acrylate, isobornyl methacrylate, benzyl methacrylate, 3,3,5 trimethylcyclohexyl acrylate, propyl methacrylate, adamantyl acrylate, adamantly methacrylate, dicyclopentanyl acrylate, dicyclopentanyl methacrylate, norbornyl acrylate, styrene, alpha-methyl styrene, or mixtures thereof.

According to still other embodiments, the monomer component a2 may be an acidic monomer having an acidic group and an ethylenically unsaturated group. According to yet other embodiments, the monomer component a2 may be an acid containing (meth)acrylic monomer. According to still other embodiments, monomer component a2 may include an acidic monomer selected from, but is not limited to, an acrylic acid, methacrylic acid, itaconic acid, fumaric acid, crotonic acid, citraconic acid, maleic acid, oleic acid, β-carboxyethyl(meth)acrylate, 2-sulfoethyl methacrylate, styrene sulfonic acid, 2-acrylamido-2-methylpropanesulfonic acid, vinylphosphonic acid, or mixtures thereof.

According to still other embodiments, the (meth)acrylic based polymeric component A may include a particular content of the monomer component a1. For example, the content of the monomer component a1 in the (meth)acrylic based polymeric component A may be at least about 40 wt. % for a total weight of the (meth)acrylic based polymeric component A, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the monomer component a1 in the (meth)acrylic based polymeric component A may be not greater than about 99 wt. % for a total weight of the (meth)acrylic based polymeric component A, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the monomer component a1 in the (meth)acrylic based polymeric component A may be within a range between any of the minimum and maximum values noted above. It will be further appreciated that the content of the content of the monomer component a1 in the (meth)acrylic based polymeric component A may be any value between any of the minimum and maximum values noted above.

According to still other embodiments, the (meth)acrylic based polymeric component A may include a particular content of the monomer component a2. For example, the content of the monomer component a2 in the (meth)acrylic based polymeric component A may be at least about 0.1 wt. % for a total weight of the (meth)acrylic based polymeric component A, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component a2 in the (meth)acrylic based polymeric component A may be not greater than about 20.0 wt. % for a total weight of the (meth)acrylic based polymeric component A, such as, not greater than about 19.5 wt. % or not greater than about 19.0 wt. % or not greater than about 18.5 wt. % or not greater than about 18.0 wt. % or not greater than about 17.5 wt. % or not greater than about 17.0 wt. % or not greater than about 16.5 wt. % or not greater than about 16.0 wt. % or not greater than about 15.5 wt. % or not greater than about 15.0 wt. % or not greater than about 14.5 wt. % or not greater than about 14.0 wt. % or not greater than about 13.5 wt. % or not greater than about 13.0 wt. % or not greater than about 12.5 wt. % or not greater than about 12.0 wt. %. It will be appreciated that the content of the monomer component a2 in the (meth)acrylic based polymeric component A may be within a range between any of the minimum and maximum values noted above. It will be further appreciated that the content of the content of the monomer component a2 in the (meth)acrylic based polymeric component A may be any value between any of the minimum and maximum values noted above.

According to still other embodiments, the (meth)acrylic based polymeric component A may further include a monomer component a3. According to particular embodiments, the monomer component a3 may be different than both the monomer component a1 and the monomer component a2.

According to certain embodiments, the monomer component a3 may be an ethylenically unsaturated monomer. According to still other embodiments, the monomer component a3 may include an ethylenically unsaturated functional monomer selected from hydroxyl containing (meth)acrylic ester or acrylamide. According to certain embodiments, the monomer component a3 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component A may include a particular content of the monomer component a3. For example, the content of the monomer component a3 in the (meth)acrylic based polymeric component A may be at least about 0.1 wt. % for a total weight of the (meth)acrylic based polymeric component A, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component a3 in the (meth)acrylic based polymeric component A may be not greater than about 60 wt. % for a total weight of the (meth)acrylic based polymeric component A, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the monomer component a3 in the (meth)acrylic based polymeric component A may be within a range between any of the minimum and maximum values noted above. It will be further appreciated that the content of the content of the monomer component a3 in the (meth)acrylic based polymeric component A may be any value between any of the minimum and maximum values noted above.

According to yet other embodiments, the adhesive composition may include a particular content of the (meth)acrylic based polymeric component B. For example, the content of the (meth)acrylic based polymeric component B in the adhesive composition may be at least about 51 wt. % for a total weight of the adhesive composition, such as, at least about 53 wt. % or at least about 55 wt. % or at least about or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to still other embodiments, the content of the (meth)acrylic based polymeric component B in the adhesive composition may be not greater than about 98 wt. % for a total weight of the adhesive composition, such as, not greater than about 95 wt. % or not greater than about 92 wt. % or not greater than about 90 wt. % or not greater than about 87 wt. % or not greater than about 85 wt. % or not greater than about 82 wt. % or even not greater than about 80 wt. %. It will be appreciated that the content of the (meth)acrylic based polymeric component B in the adhesive composition may be within a range between any of the minimum and maximum values noted above. It will be further appreciated that the content of the (meth)acrylic based polymeric component B in the adhesive composition may be any value between any of the minimum and maximum values noted above.

According to still other embodiments, the (meth)acrylic based polymeric component B may include a monomer component b1 and a monomer component b2.

According to certain embodiments, the monomer component b1 may be a C1-C24 acrylic ester. According to still other embodiments, an alkyl group of the monomer component b1 can be straight-chained, branched with one or more branching sites, or cyclic. According to yet other embodiments, the alkyl groups may include, but are not limited to, those selected from methyl, ethyl, propyl, isopropyl, butyl, isobutyl, pentyl, 2-pentyl, hexyl, heptyl, octyl, isooctyl, 2-ethylhexyl, tert-octyl, nonyl, decyl, 2-propylheptyl, undecyl, tridecyl acrylate, (2-isopropyl-5-methyl)hexyl, tetradecyl, hexadecyl, octadecyl, branched alkyl group having 16 to 22 C atoms and including at least two branching sites, phenyl, benzyl, cyclohexyl, isobornyl, adamantyl, 3,3,5 trimethylcyclohexyl, norbornyl or mixtures thereof. According to particular embodiments, the alkyl groups may include, but are not limited to, those selected from butyl, isooctyl and 2-ethylhexyl.

According to still other embodiments, the monomer component b2 may be an ethylenically unsaturated functional monomer selected from the group consisting of hydroxyl containing (meth)acrylic monomer and a nitrogen-containing monomer having a primary, secondary or tertiary amino group, or a nitrogen-containing monomer having a primary, secondary or tertiary amido group. According to certain embodiments, the monomer component b2 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component B may include a particular content of the monomer component b1. For example, the content of the monomer component b1 in the (meth)acrylic based polymeric component B may be at least about 40 wt. % for a total weight of the (meth)acrylic based polymeric component B, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the monomer component b1 in the (meth)acrylic based polymeric component B may be not greater than about 99 wt. % for a total weight of the (meth)acrylic based polymeric component B, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the monomer component b1 in the (meth)acrylic based polymeric component B may be within a range between any of the minimum and maximum values noted above. It will be further appreciated that the content of the content of the monomer component b1 in the (meth)acrylic based polymeric component B may be any value between any of the minimum and maximum values noted above.

According to still other embodiments, the (meth)acrylic based polymeric component B may include a particular content of the monomer component b2. For example, the content of the monomer component b2 in the (meth)acrylic based polymeric component B may be at least about 1 wt. % for a total weight of the (meth)acrylic based polymeric component B, such as, at least about 2 wt. % or at least about 3 wt. % or at least about 4 wt. % or at least about 5 wt. % or at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to yet other embodiments, the content of the monomer component b2 in the (meth)acrylic based polymeric component B may be not greater than about 60 wt. % for a total weight of the (meth)acrylic based polymeric component B, such as, not greater than about 57 wt. % or not greater than about 55 wt. % or not greater than about 52 wt. % or not greater than about 50 wt. % or not greater than about 47 wt. % or not greater than about 45 wt. % or not greater than about 42 wt. % or not greater than about 40 wt. % or not greater than about 37 wt. % or not greater than about 35 wt. % or not greater than about 32 wt. % or not greater than about 30 wt. % or not greater than about 27 wt. % or not greater than about 25 wt. % or not greater than about 23 wt. % or not greater than about 20 wt. %. It will be appreciated that the content of the monomer component b2 in the (meth)acrylic based polymeric component B may be within a range between any of the minimum and maximum values noted above. It will be further appreciated that the content of the content of the monomer component b2 in the (meth)acrylic based polymeric component B may be any value between any of the minimum and maximum values noted above.

According to still other embodiments, the (meth)acrylic based polymeric component B may further include a monomer component b3. According to particular embodiments, the monomer component b3 may be different than both the monomer component b 1 and the monomer component b2.

According to certain embodiments, the monomer component b3 may be an ethylenically unsaturated monomer. According to still other embodiments, the monomer component b3 may include a hydroxy-containing acrylic ester monomer having a hydroxyl group and an ethylenically unsaturated group. According to still other embodiments, the monomer component b3 may include a nitrogen-containing monomer having a primary, secondary or a tertiary amino group or an N, N-dialkylaminoalkyl (meth)acrylate and an ethylenically unsaturated group. According to still other embodiments, the monomer component b3 may include a vinyl monomer. According to certain embodiments, the monomer component b3 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component B may include a particular content of the monomer component b3. For example, the content of the monomer component b3 in the (meth)acrylic based polymeric component B may be at least about 0.1 wt. % for a total weight of the (meth)acrylic based polymeric component B, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component b3 in the (meth)acrylic based polymeric component B may be not greater than about 60 wt. % for a total weight of the (meth)acrylic based polymeric component B, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the monomer component b3 in the (meth)acrylic based polymeric component B may be within a range between any of the minimum and maximum values noted above. It will be further appreciated that the content of the content of the monomer component b3 in the (meth)acrylic based polymeric component B may be any value between any of the minimum and maximum values noted above.

According to certain embodiments, the tackifier component may include C5, C9, C5/C9, dicyclopentadiene, terpene, or their hydrogenated resins, or combinations thereof.

According to yet other embodiments, the adhesive composition may include a particular content of the tackifier component. For example, the content of the tackifier component in the adhesive composition may be at least about at least about 0.1 wt. % for a total weight of the adhesive composition, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the tackifier component in the adhesive composition may be not greater than about 30 wt. % for a total weight of the adhesive composition, such as, not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the tackifier component in the adhesive composition may be within a range between any of the minimum and maximum values noted above. It will be further appreciated that the content of the tackifier component in the adhesive composition may be any value between any of the minimum and maximum values noted above.

Referring now to a monolayer foam tape, embodiments described herein may further be generally directed to a monolayer foam tape that includes the adhesive composition formed according to embodiments described herein.

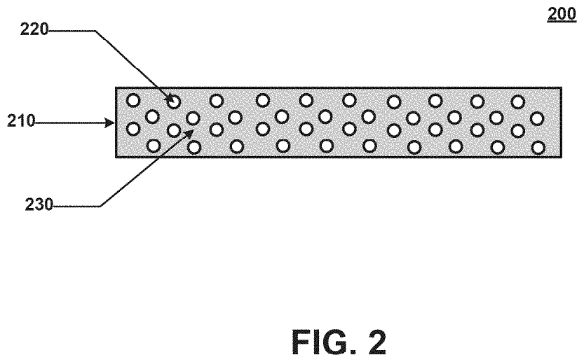

For purposes of illustration, FIG. 2 includes an illustration showing the configuration of a monolayer foam tape 200 formed according to embodiments described herein. As shown in FIG. 2, the monolayer foam tape 200 may include a foam core 210. The foam core 210 may include hollow microspheres 220 within an adhesive composition 230.

According to certain embodiments, the monolayer foam tape 200 may have a particular thickness. For example, the monolayer foam tape 200 may have a thickness of at least about 0.125 mm, such as, at least about 0.13 mm or at least about 0.135 mm or at least about 0.14 mm or at least about 0.145 mm or at least about 0.15 mm or at least about 0.155 mm or at least about 0.16 mm or at least about 0.165 mm or at least about 0.17 mm or at least about 0.175 mm or even at least about 0.18 mm. According to still other embodiments, the monolayer foam tape 200 may have a thickness of not greater than about 0.25 mm, such as, not greater than about 0.245 mm of not greater than about 0.24 mm or not greater than about 0.235 mm or not greater than about 0.23 mm or not greater than about 0.225 mm or not greater than about 0.22 mm or not greater than about 0.215 mm or not greater than about 0.21 mm or not greater than about 0.205 mm or not greater than about 0.20 mm or not greater than about 0.195 mm or not greater than about 0.19 mm or not greater than about 0.185 mm. It will be appreciated that the thickness of the monolayer foam tape 200 may be within a range between any of the minimum and maximum values noted above. It will be further appreciated that the thickness of the monolayer foam tape 200 may be any value between any of the minimum and maximum values noted above.

According to certain embodiments, the foam core 210 may have a particular thickness. For example, the foam core 210 may have a thickness of at least about 0.125 mm, such as, at least about 0.13 mm or at least about 0.135 mm or at least about 0.14 mm or at least about 0.145 mm or at least about 0.15 mm or at least about 0.155 mm or at least about 0.16 mm or at least about 0.165 mm or at least about 0.17 mm or at least about 0.175 mm or even at least about 0.18 mm. According to still other embodiments, the foam core 210 may have a thickness of not greater than about 0.25 mm, such as, not greater than about 0.245 mm of not greater than about 0.24 mm or not greater than about 0.235 mm or not greater than about 0.23 mm or not greater than about 0.225 mm or not greater than about 0.22 mm or not greater than about 0.215 mm or not greater than about 0.21 mm or not greater than about 0.205 mm or not greater than about 0.20 mm or not greater than about 0.195 mm or not greater than about 0.19 mm or not greater than about 0.185 mm. It will be appreciated that the thickness of the foam core 210 may be within a range between any of the minimum and maximum values noted above. It will be further appreciated that the thickness of the foam core 210 may be any value between any of the minimum and maximum values noted above.

According to particular embodiments, the hollow microspheres 220 may be a particular material. For example, the hollow microspheres 220 may be glass beads. According to still other embodiments, the hollow microspheres 220 may be polymeric microspheres. According to yet other embodiments, the hollow microspheres 220 may be a combination of glass beads and polymeric microspheres.

Referring now to the adhesive composition 230 formed according to embodiments described herein, the adhesive composition 230 may include a (meth)acrylic based polymeric component A, a (meth)acrylic based polymeric component B, and a tackifier component.

According to particular embodiments, the (meth)acrylic based polymeric component A of the adhesive composition 230 may be referred as a high glass transition temperature (Tg) (meth)acrylic based polymeric component. According to still other embodiments, the (meth)acrylic based polymeric component A of the adhesive composition 230 may have a particular glass transition temperature (Tg) as estimated by the Fox Equation, based on the Tgs of the homopolymer of constituent monomers and the weight percent thereof. For example, the (meth)acrylic based polymeric component A of the adhesive composition 230 may have a glass transition temperature (Tg) of at least about 40° C., such as, at least about 45° C. or at least about 50° C. or at least about 55° C. or at least about 60° C. or at least about 65° C. or at least about 70° C. or at least about 75° C. or even at least about 80° C. It will be appreciated that the glass transition temperature of the (meth)acrylic based polymeric component A of the adhesive composition 230 may be within a range between any of the values noted above. It will be further appreciated that the glass transition temperature of the (meth)acrylic based polymeric component A of the adhesive composition 230 may be any value between any of the values noted above.

According to still other embodiments, the (meth)acrylic based polymeric component A of the adhesive composition 230 may have a particular molecular weight. For example, the (meth)acrylic based polymeric component A of the adhesive composition 230 may have a molecular weight of at least about 5,000 g/mol, such as, at least about 7,500 g/mol or at least about 10,000 g/mol or at least about 12,500 g/mol or at least about 15,000 g/mol or at least about 17,500 g/mol or at least about 20,000 g/mol or at least about 25,000 g/mol or at least about 27,500 g/mol or at least about 30,000 g/mol or at least about 32,500 g/mol or at least about 35,000 g/mol or at least about 37,500 g/mol or at least about 40,000 g/mol or at least about 42,500 g/mol or even at least about 45,000 g/mol According to still other embodiments, the (meth)acrylic based polymeric component A of the adhesive composition 230 may have a molecular weight of not greater than about 200,000 g/mol, such as, not greater than about 150,000 g/mol or even not greater than about 100,000 g/mol. It will be appreciated that the molecular weight of the (meth)acrylic based polymeric component A may be within a range between any of the minimum and maximum values noted above. It will be further appreciated that the molecular weight of the (meth)acrylic based polymeric component A of the adhesive composition 230 may be any value between any of the minimum and maximum values noted above.

According to still other embodiments, the (meth)acrylic based polymeric component A of the adhesive composition 230 may be acidic. For purposes of embodiments described herein, the term “acidic” may be defined as containing an acid functional monomer in polymeric component A. According to certain embodiments, the overall level of acidic monomer in component A may be greater than about 1% by weight, or greater than about 3% by weight, or greater than 5% by weight, or greater than about 7% by weight.

According to particular embodiments, the (meth)acrylic based polymeric component B of the adhesive composition 230 may be referred as a low glass transition temperature (Tg) (meth)acrylic based polymeric component. According to still other embodiments, the (meth)acrylic based polymeric component B of the adhesive composition 230 may have a particular glass transition temperature (Tg) as estimated by the Fox Equation, based on the Tgs of the homopolymer of constituent monomers and the weight percent thereof. For example, the (meth)acrylic based polymeric component B of the adhesive composition 230 may have a glass transition temperature (Tg) of not greater than about 20° C., such as, not greater than about 15° C. or not greater than about 10° C. or not greater than about 5° C. or even not greater than about 0° C. It will be appreciated that the glass transition temperature of the (meth)acrylic based polymeric component B of the adhesive composition 230 may be within a range between any of the values noted above. It will be further appreciated that the glass transition temperature of the (meth)acrylic based polymeric component B of the adhesive composition 230 may be any value between any of the values noted above.

According to still other embodiments, the (meth)acrylic based polymeric component B of the adhesive composition 230 may have a particular molecular weight. For example, the (meth)acrylic based polymeric component B of the adhesive composition 230 may have a molecular weight of at least 200,000 g/mol, such as, at least about 400,000 g/mol or at least about 600,000 g/mol or at least about 800,000 g/mol or at least about 1,000,000 g/mol or at least about 1,200,000 g/mol or at least about 1,400,000 g/mol or at least about 1,600,000 g/mol or at least about 1,800,000 g/mol or at least about 2,000,000 g/mol or at least about 2,200,000 g/mol or at least about 2,400,000 g/mol, or at least about 2,600,000 g/mol or at least about 2,800,000 g/mol or at least about 3,000,000 g/mol. According to still other embodiments, the (meth)acrylic based polymeric component B of the adhesive composition 230 may have a molecular weigh of not greater than about 20,000,000 g/mol, such as, not greater than about 15,000,000 g/mol. It will be appreciated that the molecular weight of the (meth)acrylic based polymeric component B of the adhesive composition 230 may be within a range between any of the minimum and maximum values noted above. It will be further appreciated that the molecular weight of the (meth)acrylic based polymeric component B of the adhesive composition 230 may be any value between any of the minimum and maximum values noted above.

According to still other embodiments, the (meth)acrylic based polymeric component B may be basic. For purposes of embodiments described herein, the term “basic” may be defined as containing a basic monomer in polymeric component B. According to some embodiments, the basic monomer may be a nitrogen containing monomer having a primary, secondary or tertiary amino group, or the basic monomer may be a nitrogen containing monomer having a primary, secondary, or tertiary amido group. According to some embodiments, the overall level of basic monomer in component B may be greater than about 1% by weight, or greater than about 3% by weight, or greater than 5% by weight, or greater than about 7%, or greater than about 9% by weight, or greater than about 11% by weight, or greater than about 13% by weight.

According to yet other embodiments, the adhesive composition 230 may include a particular content of the (meth)acrylic based polymeric component A. For example, the content of the (meth)acrylic based polymeric component A in the adhesive composition 230 may be at least about 2.0 wt. % for a total weight of the adhesive composition 230, such as, at least about 2.5 wt. % or at least about 3.0 wt. % or at least about or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or at least about 7.0 wt. % or at least about 7.5 wt. % or at least about 8.5 wt. % or at least about 9.0 wt. % or at least about 9.5 wt. % or even at least about 10.0 wt. %. According to still other embodiments, the content of the (meth)acrylic based polymeric component A in the adhesive composition 230 may be not greater than about 49.0 wt. % for a total weight of the adhesive composition 230, such as, not greater than about 47.0 wt. % or not greater than about 45.0 wt. % or not greater than about 42.0 wt. % or not greater than about 40.0 wt. % or not greater than about 37.0 wt. % or not greater than about 35.0 wt. % or not greater than about 32.0 wt. % or not greater than about 30.0 wt. % or not greater than about 27.0 wt. % or not greater than about 25.0 wt. % or not greater than about 22.0 wt. % or not greater than about 20.0 wt. % or not greater than about 17.0 wt. % or not greater than about 15.0 wt. % or even not greater than about 12.0 wt. %. It will be appreciated that the content of the (meth)acrylic based polymeric component A in the adhesive composition 230 may be within a range between any of the minimum and maximum values noted above. It will be further appreciated that the content of the (meth)acrylic based polymeric component A in the adhesive composition 230 may be any value between any of the minimum and maximum values noted above.

According to still other embodiments, the (meth)acrylic based polymeric component A of the adhesive composition 230 may include a monomer component a1 and a monomer component a2.

According to certain embodiments, the monomer component a1 may be an ethylenically unsaturated monomer. According to still other embodiments, the monomer component a1 may include, but is not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl acrylate, cyclohexyl methacrylate, isobornyl acrylate, isobornyl methacrylate, benzyl methacrylate, 3,3,5 trimethylcyclohexyl acrylate, propyl methacrylate, adamantyl acrylate, adamantly methacrylate, dicyclopentanyl acrylate, dicyclopentanyl methacrylate, norbornyl acrylate, styrene, alpha-methyl styrene, or mixtures thereof.

According to still other embodiments, the monomer component a2 may be an acidic monomer having an acidic group and an ethylenically unsaturated group. According to yet other embodiments, the monomer component a2 may be an acid containing (meth)acrylic monomer. According to still other embodiments, monomer component a2 may include an acidic monomer selected from, but is not limited to, an acrylic acid, methacrylic acid, itaconic acid, fumaric acid, crotonic acid, citraconic acid, maleic acid, oleic acid, β-carboxyethyl(meth)acrylate, 2-sulfoethyl methacrylate, styrene sulfonic acid, 2-acrylamido-2-methylpropanesulfonic acid, vinylphosphonic acid, or mixtures thereof.

According to still other embodiments, the (meth)acrylic based polymeric component A of the adhesive composition 230 may include a particular content of the monomer component a1. For example, the content of the monomer component a1 in the (meth)acrylic based polymeric component A of the adhesive composition 230 may be at least about 40 wt. % for a total weight of the (meth)acrylic based polymeric component A of the adhesive composition 230, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the monomer component a1 in the (meth)acrylic based polymeric component A of the adhesive composition 230 may be not greater than about 99 wt. % for a total weight of the (meth)acrylic based polymeric component A of the adhesive composition 230, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the monomer component a1 in the (meth)acrylic based polymeric component A of the adhesive composition 230 may be within a range between any of the minimum and maximum values noted above. It will be further appreciated that the content of the content of the monomer component a1 in the (meth)acrylic based polymeric component A of the adhesive composition 230 may be any value between any of the minimum and maximum values noted above.

According to still other embodiments, the (meth)acrylic based polymeric component A of the adhesive composition 230 may include a particular content of the monomer component a2. For example, the content of the monomer component a2 in the (meth)acrylic based polymeric component A of the adhesive composition 230 may be at least about 0.1 wt. % for a total weight of the (meth)acrylic based polymeric component A of the adhesive composition 230, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component a2 in the (meth)acrylic based polymeric component A of the adhesive composition 230 may be not greater than about 20.0 wt. % for a total weight of the (meth)acrylic based polymeric component A of the adhesive composition 230, such as, not greater than about 19.5 wt. % or not greater than about 19.0 wt. % or not greater than about 18.5 wt. % or not greater than about 18.0 wt. % or not greater than about 17.5 wt. % or not greater than about 17.0 wt. % or not greater than about 16.5 wt. % or not greater than about 16.0 wt. % or not greater than about 15.5 wt. % or not greater than about 15.0 wt. % or not greater than about 14.5 wt. % or not greater than about 14.0 wt. % or not greater than about 13.5 wt. % or not greater than about 13.0 wt. % or not greater than about 12.5 wt. % or not greater than about 12.0 wt. %. It will be appreciated that the content of the monomer component a2 in the (meth)acrylic based polymeric component A of the adhesive composition 230 may be within a range between any of the minimum and maximum values noted above. It will be further appreciated that the content of the content of the monomer component a2 in the (meth)acrylic based polymeric component A of the adhesive composition 230 may be any value between any of the minimum and maximum values noted above.

According to still other embodiments, the (meth)acrylic based polymeric component A of the adhesive composition 230 may further include a monomer component a3. According to particular embodiments, the monomer component a3 may be different than both the monomer component a1 and the monomer component a2.

According to certain embodiments, the monomer component a3 may be an ethylenically unsaturated monomer. According to still other embodiments, the monomer component a3 may include an ethylenically unsaturated functional monomer selected from hydroxyl containing (meth)acrylic ester or acrylamide. According to certain embodiments, the monomer component a3 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component A of the adhesive composition 230 may include a particular content of the monomer component a3. For example, the content of the monomer component a3 in the (meth)acrylic based polymeric component A of the adhesive composition 230 may be at least about 0.1 wt. % for a total weight of the (meth)acrylic based polymeric component A of the adhesive composition 230, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component a3 in the (meth)acrylic based polymeric component A of the adhesive composition 230 may be not greater than about 60 wt. % for a total weight of the (meth)acrylic based polymeric component A of the adhesive composition 230, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the monomer component a3 in the (meth)acrylic based polymeric component A of the adhesive composition 230 may be within a range between any of the minimum and maximum values noted above. It will be further appreciated that the content of the content of the monomer component a3 in the (meth)acrylic based polymeric component A of the adhesive composition 230 may be any value between any of the minimum and maximum values noted above.

According to yet other embodiments, the adhesive composition 230 may include a particular content of the (meth)acrylic based polymeric component B of the adhesive composition 230. For example, the content of the (meth)acrylic based polymeric component B of the adhesive composition 230 in the adhesive composition 230 may be at least about 51 wt. % for a total weight of the adhesive composition 230, such as, at least about 53 wt. % or at least about 55 wt. % or at least about or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to still other embodiments, the content of the (meth)acrylic based polymeric component B of the adhesive composition 230 in the adhesive composition 230 may be not greater than about 98 wt. % for a total weight of the adhesive composition 230, such as, not greater than about 95 wt. % or not greater than about 92 wt. % or not greater than about 90 wt. % or not greater than about 87 wt. % or not greater than about 85 wt. % or not greater than about 82 wt. % or even not greater than about 80 wt. %. It will be appreciated that the content of the (meth)acrylic based polymeric component B of the adhesive composition 230 in the adhesive composition 230 may be within a range between any of the minimum and maximum values noted above. It will be further appreciated that the content of the (meth)acrylic based polymeric component B of the adhesive composition 230 in the adhesive composition 230 may be any value between any of the minimum and maximum values noted above.

According to still other embodiments, the (meth)acrylic based polymeric component B of the adhesive composition 230 may include a monomer component b1 and a monomer component b2.

According to certain embodiments, the monomer component b1 may be a C1-C24 acrylic ester. According to still other embodiments, an alkyl group of the monomer component b1 can be straight-chained, branched with one or more branching sites, or cyclic. According to yet other embodiments, the alkyl groups may include, but are not limited to, those selected from methyl, ethyl, propyl, isopropyl, butyl, isobutyl, pentyl, 2-pentyl, hexyl, heptyl, octyl, isooctyl, 2-ethylhexyl, tert-octyl, nonyl, decyl, 2-propylheptyl, undecyl, tridecyl acrylate, (2-isopropyl-5-methyl)hexyl, tetradecyl, hexadecyl, octadecyl, branched alkyl group having 16 to 22 C atoms and including at least two branching sites, phenyl, benzyl, cyclohexyl, isobornyl, adamantyl, 3,3,5 trimethylcyclohexyl, norbornyl or mixtures thereof. According to particular embodiments, the alkyl groups may include, but are not limited to, those selected from butyl, isooctyl and 2-ethylhexyl.

According to still other embodiments, the monomer component b2 may be an ethylenically unsaturated functional monomer selected from the group consisting of hydroxyl containing (meth)acrylic monomer and a nitrogen-containing monomer having a primary, secondary or tertiary amino group, or a nitrogen-containing monomer having a primary, secondary, or tertiary amido group. According to certain embodiments, the monomer component b2 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component B of the adhesive composition 230 may include a particular content of the monomer component b1. For example, the content of the monomer component b1 in the (meth)acrylic based polymeric component B of the adhesive composition 230 may be at least about 40 wt. % for a total weight of the (meth)acrylic based polymeric component B of the adhesive composition 230, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the monomer component b1 in the (meth)acrylic based polymeric component B of the adhesive composition 230 may be not greater than about 99 wt. % for a total weight of the (meth)acrylic based polymeric component B of the adhesive composition 230, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the monomer component b1 in the (meth)acrylic based polymeric component B of the adhesive composition 230 may be within a range between any of the minimum and maximum values noted above. It will be further appreciated that the content of the content of the monomer component b1 in the (meth)acrylic based polymeric component B of the adhesive composition 230 may be any value between any of the minimum and maximum values noted above.

According to still other embodiments, the (meth)acrylic based polymeric component B of the adhesive composition 230 may include a particular content of the monomer component b2. For example, the content of the monomer component b2 in the (meth)acrylic based polymeric component B of the adhesive composition 230 may be at least about 1 wt. % for a total weight of the (meth)acrylic based polymeric component B of the adhesive composition 230, such as, at least about 2 wt. % or at least about 3 wt. % or at least about 4 wt. % or at least about 5 wt. % or at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to yet other embodiments, the content of the monomer component b2 in the (meth)acrylic based polymeric component B of the adhesive composition 230 may be not greater than about 60 wt. % for a total weight of the (meth)acrylic based polymeric component B of the adhesive composition 230, such as, not greater than about 57 wt. % or not greater than about 55 wt. % or not greater than about 52 wt. % or not greater than about 50 wt. % or not greater than about 47 wt. % or not greater than about 45 wt. % or not greater than about 42 wt. % or not greater than about 40 wt. % or not greater than about 37 wt. % or not greater than about 35 wt. % or not greater than about 32 wt. % or not greater than about 30 wt. % or not greater than about 27 wt. % or not greater than about 25 wt. % or not greater than about 23 wt. % or not greater than about 20 wt. %. It will be appreciated that the content of the monomer component b2 in the (meth)acrylic based polymeric component B of the adhesive composition 230 may be within a range between any of the minimum and maximum values noted above. It will be further appreciated that the content of the content of the monomer component b2 in the (meth)acrylic based polymeric component B of the adhesive composition 230 may be any value between any of the minimum and maximum values noted above.

According to still other embodiments, the (meth)acrylic based polymeric component B of the adhesive composition 230 may further include a monomer component b3. According to particular embodiments, the monomer component b3 may be different than both the monomer component b1 and the monomer component b2.

According to certain embodiments, the monomer component b3 may be an ethylenically unsaturated monomer. According to still other embodiments, the monomer component b3 may include an acidic monomer having an acidic group and an ethylenically unsaturated group. According to still other embodiments, the monomer component b3 may include a hydroxy-containing acrylic ester monomer having a hydroxyl group and an ethylenically unsaturated group. According to still other embodiments, the monomer component b3 may include a nitrogen-containing monomer having a primary, secondary or a tertiary amino group or a nitrogen-containing monomer having a primary, secondary, or tertiary amido group and an ethylenically unsaturated group. According to still other embodiments, the monomer component b3 may include a vinyl monomer. According to certain embodiments, the monomer component b2 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component B of the adhesive composition 230 may include a particular content of the monomer component b3. For example, the content of the monomer component b3 in the (meth)acrylic based polymeric component B of the adhesive composition 230 may be at least about 0.1 wt. % for a total weight of the (meth)acrylic based polymeric component B of the adhesive composition 230, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component b3 in the (meth)acrylic based polymeric component B of the adhesive composition 230 may be not greater than about 60 wt. % for a total weight of the (meth)acrylic based polymeric component B of the adhesive composition 230, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the monomer component b3 in the (meth)acrylic based polymeric component B of the adhesive composition 230 may be within a range between any of the minimum and maximum values noted above. It will be further appreciated that the content of the content of the monomer component b3 in the (meth)acrylic based polymeric component B of the adhesive composition 230 may be any value between any of the minimum and maximum values noted above.

According to certain embodiments, the tackifier component of the adhesive composition 230 may include C5, C9, C5/C9, dicyclopentadiene, terpene, or their hydrogenated resins, or combinations thereof.

According to yet other embodiments, the adhesive composition 230 may include a particular content of the tackifier component of the adhesive composition 230. For example, the content of the tackifier component of the adhesive composition 230 in the adhesive composition 230 may be at least about at least about 0.1 wt. % for a total weight of the adhesive composition 230, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the tackifier component of the adhesive composition 230 in the adhesive composition 230 may be not greater than about 30 wt. % for a total weight of the adhesive composition 230, such as, not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the tackifier component of the adhesive composition 230 in the adhesive composition 230 may be within a range between any of the minimum and maximum values noted above. It will be further appreciated that the content of the tackifier component of the adhesive composition 230 in the adhesive composition 230 may be any value between any of the minimum and maximum values noted above.

Referring now to a foam tape, embodiments described herein may further be generally directed to a foam tape that includes a foam core and at least a first adhesive layer overlying a first surface of the foam core where the first adhesive layer includes the adhesive composition formed according to embodiments described herein.

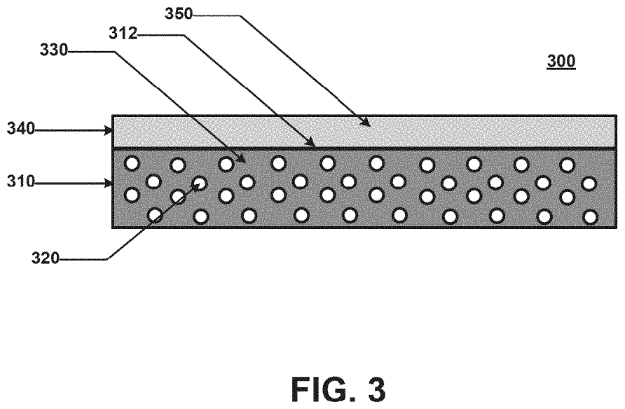

For purposes of illustration, FIG. 3 includes an illustration showing the configuration of a foam tape 300 formed according to embodiments described herein. Foam tape 300 may include a foam core 310 and a first adhesive layer 340 overlying a first surface 312 of the foam core 310. The foam core 310 may include hollow microspheres 320 within a foam material 330. The first adhesive layer 340 may include a first adhesive composition 350.

According to certain embodiments, the foam tape 300 may have a particular thickness. For example, the foam tape 300 may have a thickness of at least about 0.10 mm, such as, at least about 0.15 mm or at least about 0.20 mm or at least about 0.25 mm or at least about 0.30 mm or at least about 0.35 mm or at least about 0.40 mm or at least about 0.45 mm or even at least about 0.50 mm. It will be appreciated that the thickness of the foam tape 300 may be within a range between any of the minimum and maximum values noted above. It will be further appreciated that the thickness of the foam tape 300 may be any value between any of the minimum and maximum values noted above.

According to certain embodiments, the foam core 310 may have a particular thickness. For example, the foam core 310 may have a thickness of at least about 0.125 mm, such as, at least about 0.13 mm or at least about 0.135 mm or at least about 0.14 mm or at least about 0.145 mm or at least about 0.15 mm or at least about 0.155 mm or at least about 0.16 mm or at least about 0.165 mm or at least about 0.17 mm or at least about 0.175 mm or even at least about 0.18 mm. According to still other embodiments, the foam core 310 may have a thickness of not greater than about 0.25 mm, such as, not greater than about 0.245 mm of not greater than about 0.24 mm or not greater than about 0.235 mm or not greater than about 0.23 mm or not greater than about 0.225 mm or not greater than about 0.22 mm or not greater than about 0.215 mm or not greater than about 0.21 mm or not greater than about 0.205 mm or not greater than about 0.20 mm or not greater than about 0.195 mm or not greater than about 0.19 mm or not greater than about 0.185 mm. It will be appreciated that the thickness of the foam core 310 may be within a range between any of the minimum and maximum values noted above. It will be further appreciated that the thickness of the foam core 310 may be any value between any of the minimum and maximum values noted above.

According to particular embodiments, the hollow microspheres 320 may be a particular material. For example, the hollow microspheres 320 may be glass beads. According to still other embodiments, the hollow microspheres 320 may be polymeric microspheres. According to yet other embodiments, the hollow microspheres 320 may be a combination of glass beads and polymeric microspheres.

According to still other embodiments, the foam material 330 may be a particular material. For example, the foam material 330 may be an acrylic material. According to still other embodiments, the foam material 330 may be a polyurethane material. According to yet other embodiments, the foam material 330 may be a polyethylene material. According to still other embodiments, the foam material 330 may be a PVC material. According to other embodiments, the foam material 330 may be any combination an acrylic material, a polyurethane material, a polyethylene material, or a PVC material.

According to still other embodiments, the foam material 330 may be an acrylic foam. According to yet other embodiments, the foam material 330 may be a polyurethane foam.

According to certain embodiments, the first adhesive layer 340 may have a particular thickness. For example, the first adhesive layer 340 may have a thickness of at least about 0.125 mm, such as, at least about 0.13 mm or at least about 0.135 mm or at least about 0.14 mm or at least about 0.145 mm or at least about 0.15 mm or at least about 0.155 mm or at least about 0.16 mm or at least about 0.165 mm or at least about 0.17 mm or at least about 0.175 mm or even at least about 0.18 mm. According to still other embodiments, the first adhesive layer 340 may have a thickness of not greater than about 0.25 mm, such as, not greater than about 0.245 mm of not greater than about 0.24 mm or not greater than about 0.235 mm or not greater than about 0.23 mm or not greater than about 0.225 mm or not greater than about 0.22 mm or not greater than about 0.215 mm or not greater than about 0.21 mm or not greater than about 0.205 mm or not greater than about 0.20 mm or not greater than about 0.195 mm or not greater than about 0.19 mm or not greater than about 0.185 mm. It will be appreciated that the thickness of the first adhesive layer 340 may be within a range between any of the minimum and maximum values noted above. It will be further appreciated that the thickness of the first adhesive layer 340 may be any value between any of the minimum and maximum values noted above.

Referring now to the first adhesive composition 350 formed according to embodiments described herein, the first adhesive composition 350 may include a (meth)acrylic based polymeric component A, a (meth)acrylic based polymeric component B, and a tackifier component.

According to particular embodiments, the (meth)acrylic based polymeric component A of the first adhesive composition 350 may be referred as a high glass transition temperature (Tg) (meth)acrylic based polymeric component. According to still other embodiments, the (meth)acrylic based polymeric component A of the first adhesive composition 350 may have a particular glass transition temperature (Tg) as estimated by the Fox Equation, based on the Tgs of the homopolymer of constituent monomers and the weight percent thereof. For example, the (meth)acrylic based polymeric component A of the first adhesive composition 350 may have a glass transition temperature (Tg) of at least about 40° C., such as, at least about 45° C. or at least about 50° C. or at least about 55° C. or at least about 60° C. or at least about 65° C. or at least about 70° C. or at least about 75° C. or even at least about 80° C. It will be appreciated that the glass transition temperature of the (meth)acrylic based polymeric component A of the first adhesive composition 350 may be within a range between any of the values noted above. It will be further appreciated that the glass transition temperature of the (meth)acrylic based polymeric component A of the first adhesive composition 350 may be any value between any of the values noted above.

According to still other embodiments, the (meth)acrylic based polymeric component A of the first adhesive composition 350 may have a particular molecular weight. For example, the (meth)acrylic based polymeric component A of the first adhesive composition 350 may have a molecular weight of at least about 5,000 g/mol, such as, at least about 7,500 g/mol or at least about 10,000 g/mol or at least about 12,500 g/mol or at least about 15,000 g/mol or at least about 17,500 g/mol or at least about 20,000 g/mol or at least about 25,000 g/mol or at least about 27,500 g/mol or at least about 30,000 g/mol or at least about 32,500 g/mol or at least about 35,000 g/mol or at least about 37,500 g/mol or at least about 40,000 g/mol or at least about 42,500 g/mol or even at least about 45,000 g/mol According to still other embodiments, the (meth)acrylic based polymeric component A of the first adhesive composition 350 may have a molecular weight of not greater than about 200,000 g/mol, such as, not greater than about 150,000 g/mol or even not greater than about 100,000 g/mol. It will be appreciated that the molecular weight of the (meth)acrylic based polymeric component A may be within a range between any of the minimum and maximum values noted above. It will be further appreciated that the molecular weight of the (meth)acrylic based polymeric component A of the first adhesive composition 350 may be any value between any of the minimum and maximum values noted above.

According to still other embodiments, the (meth)acrylic based polymeric component A of the first adhesive composition 350 may be acidic. For purposes of embodiments described herein, the term “acidic” may be defined as containing an acid functional monomer in polymeric component A. According to certain embodiments, the overall level of acidic monomer in component A may be greater than about 1% by weight, or greater than about 3% by weight, or greater than 5% by weight, or greater than about 7% by weight.

According to particular embodiments, the (meth)acrylic based polymeric component B of the first adhesive composition 350 may be referred as a low glass transition temperature (Tg) (meth)acrylic based polymeric component. According to still other embodiments, the (meth)acrylic based polymeric component B of the first adhesive composition 350 may have a particular glass transition temperature (Tg) as estimated by the Fox Equation, based on the Tgs of the homopolymer of constituent monomers and the weight percent thereof. For example, the (meth)acrylic based polymeric component B of the first adhesive composition 350 may have a glass transition temperature (Tg) of not greater than about 20° C., such as, not greater than about 15° C. or not greater than about 10° C. or not greater than about 5° C. or even not greater than about 0° C. It will be appreciated that the glass transition temperature of the (meth)acrylic based polymeric component B of the first adhesive composition 350 may be within a range between any of the values noted above. It will be further appreciated that the glass transition temperature of the (meth)acrylic based polymeric component B of the first adhesive composition 350 may be any value between any of the values noted above.

According to still other embodiments, the (meth)acrylic based polymeric component B of the first adhesive composition 350 may have a particular molecular weight. For example, the (meth)acrylic based polymeric component B of the first adhesive composition 350 may have a molecular weight of at least about 200,000 g/mol, such as, at least about 400,000 g/mol or at least about 600,000 g/mol or at least about 800,000 g/mol or at least about 1,000,000 g/mol or at least about 1,200,000 g/mol or at least about 1,400,000 g/mol or at least about 1,600,000 g/mol or at least about 1,800,000 g/mol or at least about 2,000,000 g/mol or at least about 2,200,000 g/mol or at least about 2,400,000 g/mol, or at least about 2,600,000 g/mol or at least about 2,800,000 g/mol or at least about 3,000,000 g/mol. According to still other embodiments, the (meth)acrylic based polymeric component A of the first adhesive composition 350 may have a molecular weigh of not greater than about 20,000,000 g/mol, such as, not greater than about 15,000,000 g/mol. It will be appreciated that the molecular weight of the (meth)acrylic based polymeric component B of the first adhesive composition 350 may be within a range between any of the minimum and maximum values noted above. It will be further appreciated that the molecular weight of the (meth)acrylic based polymeric component B of the first adhesive composition 350 may be any value between any of the minimum and maximum values noted above.

According to still other embodiments, the (meth)acrylic based polymeric component B may be basic. For purposes of embodiments described herein, the term “basic” may be defined as containing a basic monomer in polymeric component B. According to some embodiments, the basic monomer may be a nitrogen containing monomer having a primary, secondary or tertiary amino group, or the basic monomer may be a nitrogen containing monomer having a primary, secondary, or tertiary amido group. According to some embodiments, the overall level of basic monomer in component B may be greater than about 1% by weight, or greater than about 3% by weight, or greater than 5% by weight, or greater than about 7%, or greater than about 9%, or greater than about 11%, or greater than about 13% by weight.

According to yet other embodiments, the adhesive composition 350 may include a particular content of the (meth)acrylic based polymeric component A. For example, the content of the (meth)acrylic based polymeric component A in the first adhesive composition 350 may be at least about 2.0 wt. % for a total weight of the first adhesive composition 350, such as, at least about 2.5 wt. % or at least about 3.0 wt. % or at least about or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or at least about 7.0 wt. % or at least about 7.5 wt. % or at least about 8.5 wt. % or at least about 9.0 wt. % or at least about 9.5 wt. % or even at least about 10.0 wt. %. According to still other embodiments, the content of the (meth)acrylic based polymeric component A in the first adhesive composition 350 may be not greater than about 49.0 wt. % for a total weight of the first adhesive composition 350, such as, not greater than about 47.0 wt. % or not greater than about 45.0 wt. % or not greater than about 42.0 wt. % or not greater than about 40.0 wt. % or not greater than about 37.0 wt. % or not greater than about 35.0 wt. % or not greater than about 32.0 wt. % or not greater than about 30.0 wt. % or not greater than about 27.0 wt. % or not greater than about 25.0 wt. % or not greater than about 22.0 wt. % or not greater than about 20.0 wt. % or not greater than about 17.0 wt. % or not greater than about 15.0 wt. % or even not greater than about 12.0 wt. %. It will be appreciated that the content of the (meth)acrylic based polymeric component A in the first adhesive composition 350 may be within a range between any of the minimum and maximum values noted above. It will be further appreciated that the content of the (meth)acrylic based polymeric component A in the first adhesive composition 350 may be any value between any of the minimum and maximum values noted above.

According to still other embodiments, the (meth)acrylic based polymeric component A of the first adhesive composition 350 may include a monomer component a1 and a monomer component a2.

According to certain embodiments, the monomer component a1 may be an ethylenically unsaturated monomer. According to still other embodiments, the monomer component a1 may include, but is not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl acrylate, cyclohexyl methacrylate, isobornyl acrylate, isobornyl methacrylate, benzyl methacrylate, 3,3,5 trimethylcyclohexyl acrylate, propyl methacrylate, adamantyl acrylate, adamantly methacrylate, dicyclopentanyl acrylate, dicyclopentanyl methacrylate, norbornyl acrylate, styrene, alpha-methyl styrene, or mixtures thereof.

According to still other embodiments, the monomer component a2 may be an acidic monomer having an acidic group and an ethylenically unsaturated group. According to yet other embodiments, the monomer component a2 may be an acid containing (meth)acrylic monomer. According to still other embodiments, monomer component a2 may include an acidic monomer selected from, but is not limited to, an acrylic acid, methacrylic acid, itaconic acid, fumaric acid, crotonic acid, citraconic acid, maleic acid, oleic acid, β-carboxyethyl(meth)acrylate, 2-sulfoethyl methacrylate, styrene sulfonic acid, 2-acrylamido-2-methylpropanesulfonic acid, vinylphosphonic acid, or mixtures thereof.

According to still other embodiments, the (meth)acrylic based polymeric component A of the first adhesive composition 350 may include a particular content of the monomer component a1. For example, the content of the monomer component a1 in the (meth)acrylic based polymeric component A of the first adhesive composition 350 may be at least about 40 wt. % for a total weight of the (meth)acrylic based polymeric component A of the first adhesive composition 350, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the monomer component a1 in the (meth)acrylic based polymeric component A of the first adhesive composition 350 may be not greater than about 99 wt. % for a total weight of the (meth)acrylic based polymeric component A of the first adhesive composition 350, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the monomer component a1 in the (meth)acrylic based polymeric component A of the first adhesive composition 350 may be within a range between any of the minimum and maximum values noted above. It will be further appreciated that the content of the content of the monomer component a1 in the (meth)acrylic based polymeric component A of the first adhesive composition 350 may be any value between any of the minimum and maximum values noted above.

According to still other embodiments, the (meth)acrylic based polymeric component A of the first adhesive composition 350 may include a particular content of the monomer component a2. For example, the content of the monomer component a2 in the (meth)acrylic based polymeric component A of the first adhesive composition 350 may be at least about 0.1 wt. % for a total weight of the (meth)acrylic based polymeric component A of the first adhesive composition 350, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component a2 in the (meth)acrylic based polymeric component A of the first adhesive composition 350 may be not greater than about 20.0 wt. % for a total weight of the (meth)acrylic based polymeric component A of the first adhesive composition 350, such as, not greater than about 19.5 wt. % or not greater than about 19.0 wt. % or not greater than about 18.5 wt. % or not greater than about 18.0 wt. % or not greater than about 17.5 wt. % or not greater than about 17.0 wt. % or not greater than about 16.5 wt. % or not greater than about 16.0 wt. % or not greater than about 15.5 wt. % or not greater than about 15.0 wt. % or not greater than about 14.5 wt. % or not greater than about 14.0 wt. % or not greater than about 13.5 wt. % or not greater than about 13.0 wt. % or not greater than about 12.5 wt. % or not greater than about 12.0 wt. %. It will be appreciated that the content of the monomer component a2 in the (meth)acrylic based polymeric component A of the first adhesive composition 350 may be within a range between any of the minimum and maximum values noted above. It will be further appreciated that the content of the content of the monomer component a2 in the (meth)acrylic based polymeric component A of the first adhesive composition 350 may be any value between any of the minimum and maximum values noted above.

According to still other embodiments, the (meth)acrylic based polymeric component A of the first adhesive composition 350 may further include a monomer component a3. According to particular embodiments, the monomer component a3 may be different than both the monomer component a1 and the monomer component a2.

According to certain embodiments, the monomer component a3 may be an ethylenically unsaturated monomer. According to still other embodiments, the monomer component a3 may include an ethylenically unsaturated functional monomer selected from hydroxyl containing (meth)acrylic ester or acrylamide. According to certain embodiments, the monomer component a3 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component A of the first adhesive composition 350 may include a particular content of the monomer component a3. For example, the content of the monomer component a3 in the (meth)acrylic based polymeric component A of the first adhesive composition 350 may be at least about 0.1 wt. % for a total weight of the (meth)acrylic based polymeric component A of the first adhesive composition 350, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component a3 in the (meth)acrylic based polymeric component A of the first adhesive composition 350 may be not greater than about 60 wt. % for a total weight of the (meth)acrylic based polymeric component A of the first adhesive composition 350, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the monomer component a3 in the (meth)acrylic based polymeric component A of the first adhesive composition 350 may be within a range between any of the minimum and maximum values noted above. It will be further appreciated that the content of the content of the monomer component a3 in the (meth)acrylic based polymeric component A of the first adhesive composition 350 may be any value between any of the minimum and maximum values noted above.

According to yet other embodiments, the first adhesive composition 350 may include a particular content of the (meth)acrylic based polymeric component B. For example, the content of the (meth)acrylic based polymeric component B of the first adhesive composition 350 may be at least about 51 wt. % for a total weight of the first adhesive composition 350, such as, at least about 53 wt. % or at least about 55 wt. % or at least about or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to still other embodiments, the content of the (meth)acrylic based polymeric component B in the first adhesive composition 350 may be not greater than about 98 wt. % for a total weight of the first adhesive composition 350, such as, not greater than about 95 wt. % or not greater than about 92 wt. % or not greater than about 90 wt. % or not greater than about 87 wt. % or not greater than about 85 wt. % or not greater than about 82 wt. % or even not greater than about 80 wt. %. It will be appreciated that the content of the (meth)acrylic based polymeric component B in the first adhesive composition 350 may be within a range between any of the minimum and maximum values noted above. It will be further appreciated that the content of the (meth)acrylic based polymeric component B in the first adhesive composition 350 may be any value between any of the minimum and maximum values noted above.

According to still other embodiments, the (meth)acrylic based polymeric component B of the first adhesive composition 350 may include a monomer component b1 and a monomer component b2.

According to certain embodiments, the monomer component b1 may be a C1-C24 acrylic ester. According to still other embodiments, an alkyl group of the monomer component b1 can be straight-chained, branched with one or more branching sites, or cyclic. According to yet other embodiments, the alkyl groups may include, but are not limited to, those selected from methyl, ethyl, propyl, isopropyl, butyl, isobutyl, pentyl, 2-pentyl, hexyl, heptyl, octyl, isooctyl, 2-ethylhexyl, tert-octyl, nonyl, decyl, 2-propylheptyl, undecyl, tridecyl acrylate, (2-isopropyl-5-methyl)hexyl, tetradecyl, hexadecyl, octadecyl, branched alkyl group having 16 to 22 C atoms and including at least two branching sites, phenyl, benzyl, cyclohexyl, isobornyl, adamantyl, 3,3,5 trimethylcyclohexyl, norbornyl or mixtures thereof. According to particular embodiments, the alkyl groups may include, but are not limited to, those selected from butyl, isooctyl and 2-ethylhexyl.

According to still other embodiments, the monomer component b2 may be an ethylenically unsaturated functional monomer selected from the group consisting of hydroxyl containing (meth)acrylic monomer and a nitrogen-containing monomer having a primary, secondary or tertiary amino group, or a nitrogen-containing monomer having a primary, secondary or tertiary amino group. According to certain embodiments, the monomer component b2 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component B of the first adhesive composition 350 may include a particular content of the monomer component b 1. For example, the content of the monomer component b1 in the (meth)acrylic based polymeric component B of the first adhesive composition 350 may be at least about 40 wt. % for a total weight of the (meth)acrylic based polymeric component B of the first adhesive composition 350, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the monomer component b1 in the (meth)acrylic based polymeric component B of the first adhesive composition 350 may be not greater than about 99 wt. % for a total weight of the (meth)acrylic based polymeric component B of the first adhesive composition 350, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the monomer component b1 in the (meth)acrylic based polymeric component B of the first adhesive composition 350 may be within a range between any of the minimum and maximum values noted above. It will be further appreciated that the content of the content of the monomer component b1 in the (meth)acrylic based polymeric component B of the first adhesive composition 350 may be any value between any of the minimum and maximum values noted above.

According to still other embodiments, the (meth)acrylic based polymeric component B of the first adhesive composition 350 may include a particular content of the monomer component b2. For example, the content of the monomer component b2 in the (meth)acrylic based polymeric component B of the first adhesive composition 350 may be at least about 1 wt. % for a total weight of the (meth)acrylic based polymeric component B of the first adhesive composition 350, such as, at least about 2 wt. % or at least about 3 wt. % or at least about 4 wt. % or at least about 5 wt. % or at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to yet other embodiments, the content of the monomer component b2 in the (meth)acrylic based polymeric component B of the first adhesive composition 350 may be not greater than about 60 wt. % for a total weight of the (meth)acrylic based polymeric component B of the first adhesive composition 350, such as, not greater than about 57 wt. % or not greater than about 55 wt. % or not greater than about 52 wt. % or not greater than about 50 wt. % or not greater than about 47 wt. % or not greater than about 45 wt. % or not greater than about 42 wt. % or not greater than about 40 wt. % or not greater than about 37 wt. % or not greater than about 35 wt. % or not greater than about 32 wt. % or not greater than about 30 wt. % or not greater than about 27 wt. % or not greater than about 25 wt. % or not greater than about 23 wt. % or not greater than about 20 wt. %. It will be appreciated that the content of the monomer component b2 in the (meth)acrylic based polymeric component B of the first adhesive composition 350 may be within a range between any of the minimum and maximum values noted above. It will be further appreciated that the content of the content of the monomer component b2 in the (meth)acrylic based polymeric component B of the first adhesive composition 350 may be any value between any of the minimum and maximum values noted above.

According to still other embodiments, the (meth)acrylic based polymeric component B of the first adhesive composition 350 may further include a monomer component b3. According to particular embodiments, the monomer component b3 may be different than both the monomer component b1 and the monomer component b2.

According to certain embodiments, the monomer component b3 may be an ethylenically unsaturated monomer. According to still other embodiments, the monomer component b3 may include a hydroxy-containing acrylic ester monomer having a hydroxyl group and an ethylenically unsaturated group. According to still other embodiments, the monomer component b3 may include a nitrogen-containing monomer having a primary, secondary or a tertiary amino group or a nitrogen-containing monomer having a primary, secondary, or tertiary amido group. According to still other embodiments, the monomer component b3 may include a vinyl monomer. According to certain embodiments, the monomer component b3 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component B of the first adhesive composition 350 may include a particular content of the monomer component b3. For example, the content of the monomer component b3 in the (meth)acrylic based polymeric component B of the first adhesive composition 350 may be at least about 0.1 wt. % for a total weight of the (meth)acrylic based polymeric component B of the first adhesive composition 350, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component b3 in the (meth)acrylic based polymeric component B of the first adhesive composition 350 may be not greater than about 60 wt. % for a total weight of the (meth)acrylic based polymeric component B of the first adhesive composition 350, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the monomer component b3 in the (meth)acrylic based polymeric component B of the first adhesive composition 350 may be within a range between any of the minimum and maximum values noted above. It will be further appreciated that the content of the content of the monomer component b3 in the (meth)acrylic based polymeric component B of the first adhesive composition 350 may be any value between any of the minimum and maximum values noted above.

According to certain embodiments, the tackifier component of the first adhesive composition 350 may include C5, C9, C5/C9, dicyclopentadiene, terpene, or their hydrogenated resins, or combinations thereof.

According to yet other embodiments, the first adhesive composition 350 may include a particular content of the tackifier component. For example, the content of the tackifier component in the first adhesive composition 350 may be at least about at least about 0.1 wt. % for a total weight of the first adhesive composition 350, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the tackifier component of the first adhesive composition 350 in the first adhesive composition 350 may be not greater than about 30 wt. % for a total weight of the first adhesive composition 350 of the first adhesive layer 340, such as, not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the tackifier component in the first adhesive composition 350 may be within a range between any of the minimum and maximum values noted above. It will be further appreciated that the content of the tackifier component in the first adhesive composition 350 may be any value between any of the minimum and maximum values noted above.

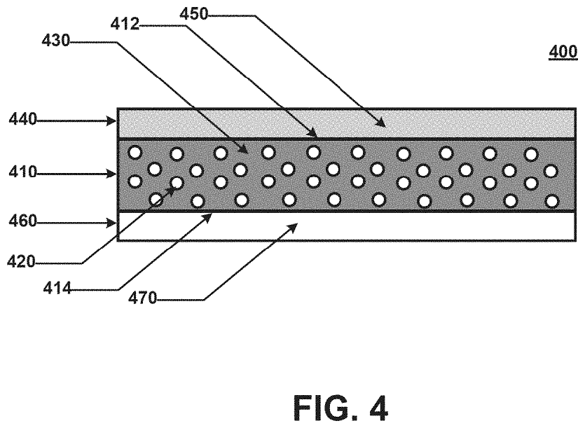

For purposes of illustration, FIG. 4 includes an illustration showing the configuration of a foam tape 400 formed according to embodiments described herein. Foam tape 400 may include a foam core 410, a first adhesive layer 440 overlying a first surface 412 of the foam core 410 and a second adhesive layer 460 overlying a second surface 414 of the foam core 410. The foam core 410 may include hollow microspheres 420 within a foam material 430. The first adhesive layer 440 may include a first adhesive composition 450 and the second adhesive layer 460 may include a second adhesive composition 470.

It will be appreciated that the foam tape 400 and all components described in reference to the foam tape 400 as shown in FIG. 4 may have any of the characteristics described herein with reference to corresponding components shown in FIG. 3. In particular, the characteristic of foam tape 400, the foam core 410, the hollow microspheres 420, the foam material 430, the first adhesive layer 440 and the first adhesive composition 450 shown in FIG. 4 may have any of the corresponding characteristics described herein in reference to foam tape 300, the foam core 310, the hollow microspheres 320, the foam material 330, the first adhesive layer 340 and the first adhesive composition 350 shown in FIG. 3.

According to certain embodiments, the second adhesive layer 460 may have a particular thickness. For example, the second adhesive layer 460 may have a thickness of at least about 0.125 mm, such as, at least about 0.13 mm or at least about 0.135 mm or at least about 0.14 mm or at least about 0.145 mm or at least about 0.15 mm or at least about 0.155 mm or at least about 0.16 mm or at least about 0.165 mm or at least about 0.17 mm or at least about 0.175 mm or even at least about 0.18 mm. According to still other embodiments, the second adhesive layer 460 may have a thickness of not greater than about 0.25 mm, such as, not greater than about 0.245 mm of not greater than about 0.24 mm or not greater than about 0.235 mm or not greater than about 0.23 mm or not greater than about 0.225 mm or not greater than about 0.22 mm or not greater than about 0.215 mm or not greater than about 0.21 mm or not greater than about 0.205 mm or not greater than about 0.20 mm or not greater than about 0.195 mm or not greater than about 0.19 mm or not greater than about 0.185 mm. It will be appreciated that the thickness of the second adhesive layer 460 may be within a range between any of the minimum and maximum values noted above. It will be further appreciated that the thickness of the second adhesive layer 460 may be any value between any of the minimum and maximum values noted above.

Referring now to the second adhesive composition 470 formed according to embodiments described herein, the second adhesive composition 470 may include a (meth)acrylic based polymeric component A, a (meth)acrylic based polymeric component B, and a tackifier component.

According to particular embodiments, the (meth)acrylic based polymeric component A of the second adhesive composition 470 may be referred as a high glass transition temperature (Tg) (meth)acrylic based polymeric component. According to still other embodiments, the (meth)acrylic based polymeric component A of the second adhesive composition 470 may have a particular glass transition temperature (Tg) as estimated by the Fox Equation, based on the Tgs of the homopolymer of constituent monomers and the weight percent thereof. For example, the (meth)acrylic based polymeric component A of the second adhesive composition 470 may have a glass transition temperature (Tg) of at least about 40° C., such as, at least about 45° C. or at least about 50° C. or at least about 55° C. or at least about 60° C. or at least about 65° C. or at least about 70° C. or at least about 75° C. or even at least about 80° C. It will be appreciated that the glass transition temperature of the (meth)acrylic based polymeric component A of the second adhesive composition 470 may be within a range between any of the values noted above. It will be further appreciated that the glass transition temperature of the (meth)acrylic based polymeric component A of the second adhesive composition 470 may be any value between any of the values noted above.

According to still other embodiments, the (meth)acrylic based polymeric component A of the second adhesive composition 470 may have a particular molecular weight. For example, the (meth)acrylic based polymeric component A of the second adhesive composition 470 may have a molecular weight of at least about 5,000 g/mol, such as, at least about 7,500 g/mol or at least about 10,000 g/mol or at least about 12,500 g/mol or at least about 15,000 g/mol or at least about 17,500 g/mol or at least about 20,000 g/mol or at least about 25,000 g/mol or at least about 27,500 g/mol or at least about 30,000 g/mol or at least about 32,500 g/mol or at least about 35,000 g/mol or at least about 37,500 g/mol or at least about 40,000 g/mol or at least about 42,500 g/mol or even at least about 45,000 g/mol According to still other embodiments, the (meth)acrylic based polymeric component A of the second adhesive composition 470 may have a molecular weight of not greater than about 200,000 g/mol, such as, not greater than about 150,000 g/mol or even not greater than about 100,000 g/mol. It will be appreciated that the molecular weight of the (meth)acrylic based polymeric component A may be within a range between any of the minimum and maximum values noted above. It will be further appreciated that the molecular weight of the (meth)acrylic based polymeric component A of the second adhesive composition 470 may be any value between any of the minimum and maximum values noted above.

According to still other embodiments, the (meth)acrylic based polymeric component A of the second adhesive composition 470 may be acidic. For purposes of embodiments described herein, the term “acidic” may be defined as containing an acid functional monomer in polymeric component A. According to certain embodiments, the overall level of acidic monomer in component A may be greater than about 1% by weight, or greater than about 3% by weight, or greater than 5% by weight, or greater than about 7% by weight.

According to particular embodiments, the (meth)acrylic based polymeric component B of the second adhesive composition 470 may be referred as a low glass transition temperature (Tg) (meth)acrylic based polymeric component. According to still other embodiments, the (meth)acrylic based polymeric component B of the second adhesive composition 470 may have a particular glass transition temperature (Tg) as estimated by the Fox Equation, based on the Tgs of the homopolymer of constituent monomers and the weight percent thereof. For example, the (meth)acrylic based polymeric component B of the second adhesive composition 470 may have a glass transition temperature (Tg) of not greater than about 20° C., such as, not greater than about 15° C. or not greater than about 10° C. or not greater than about 5° C. or even not greater than about 0° C. It will be appreciated that the glass transition temperature of the (meth)acrylic based polymeric component B of the second adhesive composition 470 may be within a range between any of the values noted above. It will be further appreciated that the glass transition temperature of the (meth)acrylic based polymeric component B of the second adhesive composition 470 may be any value between any of the values noted above.

According to still other embodiments, the (meth)acrylic based polymeric component B of the second adhesive composition 470 may have a particular molecular weight. For example, the (meth)acrylic based polymeric component B of the second adhesive composition 470 may have a molecular weight of at least about 200,000 g/mol, such as, at least about 400,000 g/mol or at least about 600,000 g/mol or at least about 800,000 g/mol or at least about 1,000,000 g/mol or at least about 1,200,000 g/mol or at least about 1,400,000 g/mol or at least about 1,600,000 g/mol or at least about 1,800,000 g/mol or at least about 2,000,000 g/mol or at least about 2,200,000 g/mol or at least about 2,400,000 g/mol, or at least about 2,600,000 g/mol or at least about 2,800,000 g/mol or at least about 3,000,000 g/mol. According to still other embodiments, the (meth)acrylic based polymeric component B of the second adhesive composition 470 may have a molecular weigh of not greater than about 20,000,000 g/mol, such as, not greater than about15,000,000. It will be appreciated that the molecular weight of the (meth)acrylic based polymeric component B of the second adhesive composition 470 may be within a range between any of the minimum and maximum values noted above. It will be further appreciated that the molecular weight of the (meth)acrylic based polymeric component B of the second adhesive composition 470 may be any value between any of the minimum and maximum values noted above.

According to still other embodiments, the (meth)acrylic based polymeric component B may be basic. For purposes of embodiments described herein, the term “basic” may be defined as containing a basic monomer in polymeric component B. According to some embodiments, the basic monomer may be a nitrogen containing monomer having a primary, secondary or tertiary amino group, or the basic monomer may be a nitrogen containing monomer having a primary, secondary, or tertiary amido group. According to some embodiments, the overall level of basic monomer in component B may be greater than about 1% by weight, or greater than about 3% by weight, or greater than 5% by weight, or greater than about 7% by weight, or greater than about 9% by weight, or greater than about 11% by weight, or greater than about 13% by weight.

According to yet other embodiments, the adhesive composition 350 may include a particular content of the (meth)acrylic based polymeric component A. For example, the content of the (meth)acrylic based polymeric component A in the second adhesive composition 470 may be at least about 2.0 wt. % for a total weight of the second adhesive composition 470, such as, at least about 2.5 wt. % or at least about 3.0 wt. % or at least about or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or at least about 7.0 wt. % or at least about 7.5 wt. % or at least about 8.5 wt. % or at least about 9.0 wt. % or at least about 9.5 wt. % or even at least about 10.0 wt. %. According to still other embodiments, the content of the (meth)acrylic based polymeric component A in the second adhesive composition 470 may be not greater than about 49.0 wt. % for a total weight of the second adhesive composition 470, such as, not greater than about 47.0 wt. % or not greater than about 45.0 wt. % or not greater than about 42.0 wt. % or not greater than about 40.0 wt. % or not greater than about 37.0 wt. % or not greater than about 35.0 wt. % or not greater than about 32.0 wt. % or not greater than about 30.0 wt. % or not greater than about 27.0 wt. % or not greater than about 25.0 wt. % or not greater than about 22.0 wt. % or not greater than about 20.0 wt. % or not greater than about 17.0 wt. % or not greater than about 15.0 wt. % or even not greater than about 12.0 wt. %. It will be appreciated that the content of the (meth)acrylic based polymeric component A in the second adhesive composition 470 may be within a range between any of the minimum and maximum values noted above. It will be further appreciated that the content of the (meth)acrylic based polymeric component A in the second adhesive composition 470 may be any value between any of the minimum and maximum values noted above.

According to still other embodiments, the (meth)acrylic based polymeric component A of the second adhesive composition 470 may include a monomer component a1 and a monomer component a2.

According to certain embodiments, the monomer component a1 may be an ethylenically unsaturated monomer. According to still other embodiments, the monomer component a1 may include, but is not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl acrylate, cyclohexyl methacrylate, isobornyl acrylate, isobornyl methacrylate, benzyl methacrylate, 3,3,5 trimethylcyclohexyl acrylate, propyl methacrylate, adamantyl acrylate, adamantly methacrylate, dicyclopentanyl acrylate, dicyclopentanyl methacrylate, norbornyl acrylate, styrene, alpha-methyl styrene, or mixtures thereof.

According to still other embodiments, the monomer component a2 may be an acidic monomer having an acidic group and an ethylenically unsaturated group. According to yet other embodiments, the monomer component a2 may be an acid containing (meth)acrylic monomer. According to still other embodiments, monomer component a2 may include an acidic monomer selected from, but is not limited to, an acrylic acid, methacrylic acid, itaconic acid, fumaric acid, crotonic acid, citraconic acid, maleic acid, oleic acid, β-carboxyethyl(meth)acrylate, 2-sulfoethyl methacrylate, styrene sulfonic acid, 2-acrylamido-2-methylpropanesulfonic acid, vinylphosphonic acid, or mixtures thereof.

According to still other embodiments, the (meth)acrylic based polymeric component A of the second adhesive composition 470 may include a particular content of the monomer component a1. For example, the content of the monomer component a1 in the (meth)acrylic based polymeric component A of the second adhesive composition 470 may be at least about 40 wt. % for a total weight of the (meth)acrylic based polymeric component A of the second adhesive composition 470, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the monomer component a1 in the (meth)acrylic based polymeric component A of the second adhesive composition 470 may be not greater than about 99 wt. % for a total weight of the (meth)acrylic based polymeric component A of the second adhesive composition 470, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the monomer component a1 in the (meth)acrylic based polymeric component A of the second adhesive composition 470 may be within a range between any of the minimum and maximum values noted above. It will be further appreciated that the content of the content of the monomer component a1 in the (meth)acrylic based polymeric component A of the second adhesive composition 470 may be any value between any of the minimum and maximum values noted above.

According to still other embodiments, the (meth)acrylic based polymeric component A of the second adhesive composition 470 may include a particular content of the monomer component a2. For example, the content of the monomer component a2 in the (meth)acrylic based polymeric component A of the second adhesive composition 470 may be at least about 0.1 wt. % for a total weight of the (meth)acrylic based polymeric component A of the second adhesive composition 470, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component a2 in the (meth)acrylic based polymeric component A of the second adhesive composition 470 may be not greater than about 20.0 wt. % for a total weight of the (meth)acrylic based polymeric component A of the second adhesive composition 470, such as, not greater than about 19.5 wt. % or not greater than about 19.0 wt. % or not greater than about 18.5 wt. % or not greater than about 18.0 wt. % or not greater than about 17.5 wt. % or not greater than about 17.0 wt. % or not greater than about 16.5 wt. % or not greater than about 16.0 wt. % or not greater than about 15.5 wt. % or not greater than about 15.0 wt. % or not greater than about 14.5 wt. % or not greater than about 14.0 wt. % or not greater than about 13.5 wt. % or not greater than about 13.0 wt. % or not greater than about 12.5 wt. % or not greater than about 12.0 wt. %. It will be appreciated that the content of the monomer component a2 in the (meth)acrylic based polymeric component A of the second adhesive composition 470 may be within a range between any of the minimum and maximum values noted above. It will be further appreciated that the content of the content of the monomer component a2 in the (meth)acrylic based polymeric component A of the second adhesive composition 470 may be any value between any of the minimum and maximum values noted above.

According to still other embodiments, the (meth)acrylic based polymeric component A of the second adhesive composition 470 may further include a monomer component a3. According to particular embodiments, the monomer component a3 may be different than both the monomer component a1 and the monomer component a2.

According to certain embodiments, the monomer component a3 may be an ethylenically unsaturated monomer. According to still other embodiments, the monomer component a3 may include an ethylenically unsaturated functional monomer selected from hydroxyl containing (meth)acrylic ester or acrylamide. According to certain embodiments, the monomer component a3 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component A of the second adhesive composition 470 may include a particular content of the monomer component a3. For example, the content of the monomer component a3 in the (meth)acrylic based polymeric component A of the second adhesive composition 470 may be at least about 0.1 wt. % for a total weight of the (meth)acrylic based polymeric component A of the second adhesive composition 470, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component a3 in the (meth)acrylic based polymeric component A of the second adhesive composition 470 may be not greater than about 60 wt. % for a total weight of the (meth)acrylic based polymeric component A of the second adhesive composition 470, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the monomer component a3 in the (meth)acrylic based polymeric component A of the second adhesive composition 470 may be within a range between any of the minimum and maximum values noted above. It will be further appreciated that the content of the content of the monomer component a3 in the (meth)acrylic based polymeric component A of the second adhesive composition 470 may be any value between any of the minimum and maximum values noted above.

According to yet other embodiments, the second adhesive composition 470 may include a particular content of the (meth)acrylic based polymeric component B. For example, the content of the (meth)acrylic based polymeric component B of the second adhesive composition 470 may be at least about 51 wt. % for a total weight of the second adhesive composition 470, such as, at least about 53 wt. % or at least about 55 wt. % or at least about or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to still other embodiments, the content of the (meth)acrylic based polymeric component B in the second adhesive composition 470 may be not greater than about 98 wt. % for a total weight of the second adhesive composition 470, such as, not greater than about 95 wt. % or not greater than about 92 wt. % or not greater than about 90 wt. % or not greater than about 87 wt. % or not greater than about 85 wt. % or not greater than about 82 wt. % or even not greater than about 80 wt. %. It will be appreciated that the content of the (meth)acrylic based polymeric component B in the second adhesive composition 470 may be within a range between any of the minimum and maximum values noted above. It will be further appreciated that the content of the (meth)acrylic based polymeric component B in the second adhesive composition 470 may be any value between any of the minimum and maximum values noted above.

According to still other embodiments, the (meth)acrylic based polymeric component B of the second adhesive composition 470 may include a monomer component b1 and a monomer component b2.

According to certain embodiments, the monomer component b1 may be a C1-C24 acrylic ester. According to still other embodiments, an alkyl group of the monomer component b1 can be straight-chained, branched with one or more branching sites, or cyclic. According to yet other embodiments, the alkyl groups may include, but are not limited to, those selected from methyl, ethyl, propyl, isopropyl, butyl, isobutyl, pentyl, 2-pentyl, hexyl, heptyl, octyl, isooctyl, 2-ethylhexyl, tert-octyl, nonyl, decyl, 2-propylheptyl, undecyl, tridecyl acrylate, (2-isopropyl-5-methyl)hexyl, tetradecyl, hexadecyl, octadecyl, branched alkyl group having 16 to 22 C atoms and including at least two branching sites, phenyl, benzyl, cyclohexyl, isobornyl, adamantyl, 3,3,5 trimethylcyclohexyl, norbornyl or mixtures thereof. According to particular embodiments, the alkyl groups may include, but are not limited to, those selected from butyl, isooctyl and 2-ethylhexyl.

According to still other embodiments, the monomer component b2 may be an ethylenically unsaturated functional monomer selected from the group consisting of hydroxyl containing (meth)acrylic monomer and a nitrogen-containing monomer having a primary, secondary or tertiary amino group or a nitrogen-containing monomer having a primary, secondary or tertiary amido group. According to certain embodiments, the monomer component b2 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component B of the second adhesive composition 470 may include a particular content of the monomer component b 1. For example, the content of the monomer component b1 in the (meth)acrylic based polymeric component B of the second adhesive composition 470 may be at least about 40 wt. % for a total weight of the (meth)acrylic based polymeric component B of the second adhesive composition 470, such as, at least about 43 wt. % or at least about 45 wt. % or at least about 48 wt. % or at least about 50 wt. % or at least about 53 wt. % or at least about 55 wt. % or at least about 58 wt. % or at least about 63 wt. % or at least about 65 wt. % or at least about 68 wt. % or at least about 70 wt. % or at least about 73 wt. % or at least about 75 wt. % or at least about 78 wt. % or at least about 80 wt. % or at least about 83 wt. % or at least about 85 wt. % or at least about 88 wt. % or even at least about 90 wt. %. According to yet other embodiments, the content of the monomer component b1 in the (meth)acrylic based polymeric component B of the second adhesive composition 470 may be not greater than about 99 wt. % for a total weight of the (meth)acrylic based polymeric component B of the second adhesive composition 470, such as, not greater than about 98.5 wt. % or not greater than about 98 wt. % or not greater than about 97.5 wt. % or not greater than about 97.0 wt. % or not greater than about 96.5 wt. % or not greater than about 96.0 wt. % or not greater than about 95.5 wt. % or not greater than about 95.0 wt. %. It will be appreciated that the content of the monomer component b1 in the (meth)acrylic based polymeric component B of the second adhesive composition 470 may be within a range between any of the minimum and maximum values noted above. It will be further appreciated that the content of the content of the monomer component b1 in the (meth)acrylic based polymeric component B of the second adhesive composition 470 may be any value between any of the minimum and maximum values noted above.

According to still other embodiments, the (meth)acrylic based polymeric component B of the second adhesive composition 470 may include a particular content of the monomer component b2. For example, the content of the monomer component b2 in the (meth)acrylic based polymeric component B of the second adhesive composition 470 may be at least about 1 wt. % for a total weight of the (meth)acrylic based polymeric component B of the second adhesive composition 470, such as, at least about 2 wt. % or at least about 3 wt. % or at least about 4 wt. % or at least about 5 wt. % or at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to yet other embodiments, the content of the monomer component b2 in the (meth)acrylic based polymeric component B of the second adhesive composition 470 may be not greater than about 60 wt. % for a total weight of the (meth)acrylic based polymeric component B of the second adhesive composition 470, such as, not greater than about 57 wt. % or not greater than about 55 wt. % or not greater than about 52 wt. % or not greater than about 50 wt. % or not greater than about 47 wt. % or not greater than about 45 wt. % or not greater than about 42 wt. % or not greater than about 40 wt. % or not greater than about 37 wt. % or not greater than about 35 wt. % or not greater than about 32 wt. % or not greater than about 30 wt. % or not greater than about 27 wt. % or not greater than about 25 wt. % or not greater than about 23 wt. % or not greater than about 20 wt. %. It will be appreciated that the content of the monomer component b2 in the (meth)acrylic based polymeric component B of the second adhesive composition 470 may be within a range between any of the minimum and maximum values noted above. It will be further appreciated that the content of the content of the monomer component b2 in the (meth)acrylic based polymeric component B of the second adhesive composition 470 may be any value between any of the minimum and maximum values noted above.

According to still other embodiments, the (meth)acrylic based polymeric component B of the second adhesive composition 470 may further include a monomer component b3. According to particular embodiments, the monomer component b3 may be different than both the monomer component b1 and the monomer component b2.

According to certain embodiments, the monomer component b3 may be an ethylenically unsaturated monomer. According to still other embodiments, the monomer component b3 may include a hydroxy-containing acrylic ester monomer having a hydroxyl group and an ethylenically unsaturated group. According to still other embodiments, the monomer component b3 may include a nitrogen-containing monomer having a primary, secondary or a tertiary amino group or a nitrogen-containing monomer having a primary, secondary or tertiary amido group and an ethylenically unsaturated group. According to still other embodiments, the monomer component b3 may include a vinyl monomer. According to certain embodiments, the monomer component b2 may be selected from, but are not limited to, 2-hydroxyethyl acrylate, 2-hydroxypropyl acrylate, 2-hydroxybutyl acrylate, 2-hydroxyethyl methacrylate, 2-hydroxypropyl methacrylate, 2-hydroxybutyl methacrylate, N-methyl acrylamide, N-ethyl acrylamide, N-hexyl acrylamide, N-octyl acrylamide, t-butyl acrylamide, N,N-dimethyl acrylamide, N,N˜dimethyl methacrylamide, N,N-diethyl acrylamide, N,N-diethyl methacrylamide, N,N-dimethylaminoethyl methacrylate, N,N-dimethylaminopropyl methacrylate, N,N-dimethylaminoethyl acrylate, N,N-dimethylaminopropyl acrylate, B-(dimethylamido)ethyl acrylate, dimethylaminoethyl acrylamide, N-vinylpyrrolidone; N-vinylcaprolactam, methacrylamide, acrylamide, n-hydroxymethyl acrylamide, n-hydroxyethyl acrylamide, or mixtures thereof.

According to still other embodiments, the (meth)acrylic based polymeric component B of the second adhesive composition 470 may include a particular content of the monomer component b3. For example, the content of the monomer component b3 in the (meth)acrylic based polymeric component B of the second adhesive composition 470 may be at least about 0.1 wt. % for a total weight of the (meth)acrylic based polymeric component B of the second adhesive composition 470, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the monomer component b3 in the (meth)acrylic based polymeric component B of the second adhesive composition 470 may be not greater than about 60 wt. % for a total weight of the (meth)acrylic based polymeric component B of the second adhesive composition 470, such as, not greater than about 55 wt. % or not greater than about 50 wt. % or not greater than about 45 wt. % or not greater than about 40 wt. % or not greater than about 35 wt. % or not greater than about 30 wt. % or not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the monomer component b3 in the (meth)acrylic based polymeric component B of the second adhesive composition 470 may be within a range between any of the minimum and maximum values noted above. It will be further appreciated that the content of the content of the monomer component b3 in the (meth)acrylic based polymeric component B of the second adhesive composition 470 may be any value between any of the minimum and maximum values noted above.

According to certain embodiments, the tackifier component of the second adhesive composition 470 may include C5, C9, C5/C9, dicyclopentadiene, terpene, or their hydrogenated resins, or combinations thereof.

According to yet other embodiments, the second adhesive composition 470 may include a particular content of the tackifier component. For example, the content of the tackifier component in the second adhesive composition 470 may be at least about at least about 0.1 wt. % for a total weight of the second adhesive composition 470, such as, at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to yet other embodiments, the content of the tackifier component of the second adhesive composition 470 in the second adhesive composition 470 may be not greater than about 30 wt. % for a total weight of the second adhesive composition 470 of the first adhesive layer 340, such as, not greater than about 25 wt. % or not greater than about 20 wt. % or not greater than about 18 wt. % or not greater than about 15 wt. % or not greater than about 13 wt. % or not greater than about 10 wt. %. It will be appreciated that the content of the tackifier component in the second adhesive composition 470 may be within a range between any of the minimum and maximum values noted above. It will be further appreciated that the content of the tackifier component in the second adhesive composition 470 may be any value between any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

An adhesive composition comprising: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A is acidic and has a glass transition temperature (Tg) of at least about 40° C., and wherein the (meth)acrylic based polymeric component B is basic and has a glass transition temperature (Tg) of not greater than about 20° C.

### Embodiment 2

An adhesive composition comprising: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B is basic.

### Embodiment 3

An adhesive composition comprising: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 4

The adhesive composition of any one of embodiments 1, 2 and 3, wherein the (meth)acrylic based polymeric component A has a molecular weight of at least about 5,000 g/mol.

### Embodiment 5

The adhesive composition of any one of embodiments 2 and 3, wherein the (meth)acrylic based polymeric component A has a glass transition temperature (Tg) of at least about 40° C.

### Embodiment 6

The adhesive composition of any one of embodiments 2, 3 and 5, wherein the (meth)acrylic based polymeric component B has a glass transition temperature (Tg) of not greater than about 20° C.

### Embodiment 7

The adhesive composition of embodiment 1, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group.

### Embodiment 8

The adhesive composition of any one of embodiments 2, 3, and 7, wherein the monomer component a2 is an acid containing (meth)acrylic monomer.

### Embodiment 9

The adhesive composition of any one of embodiments 1, and 2, wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 10

The adhesive composition of any one of embodiments 2, 3, and 7, wherein the (meth)acrylic based polymeric component A further comprises at least about 0.1 wt. % and not greater than about 60 wt. % of a monomer component a3 for a total weight of the (meth)acrylic based polymeric component A, wherein the monomer component a3 is an ethylenically unsaturated functional monomer selected from hydroxyl containing (meth)acrylic ester or acrylamide.

### Embodiment 11

The adhesive composition of any one of embodiments 3, and 9, wherein the (meth)acrylic based polymeric component B further comprises at least about 0.1 wt. % and not greater than about 60 wt. % of a monomer component b3 for a total weight of the (meth)acrylic based polymeric component B, wherein the monomer component b3 is an ethylenically unsaturated monomer and wherein the monomer component b3 is different than both the monomer component b1 and the monomer component b2.

### Embodiment 12

The adhesive composition of embodiment 11, wherein the monomer component b3 comprises: i. an acidic monomer having an acidic group and an ethylenically unsaturated group, ii. a hydroxy-containing acrylic ester monomer having a hydroxyl group and an ethylenically unsaturated group, iii. a nitrogen-containing monomer having a primary, secondary or a tertiary amino group or, a nitrogen-containing monomer having a primary, secondary or tertiary amido group, and an ethylenically unsaturated group, iv. a vinyl monomer, or v. a combination thereof.

### Embodiment 13

The adhesive composition of any one of embodiments 1, 2, and 3, wherein the tackifier component comprises C5, C9, C5/C9, dicyclopentadiene, terpene, or their hydrogenated resins, or combinations thereof.

### Embodiment 14

A method of forming an adhesive composition, wherein the method comprises providing a pre-adhesive mixture comprising: a pre-adhesive (meth)acrylic based polymeric component A, wherein the pre-adhesive (meth)acrylic based polymeric component A is fully polymerized; a pre-adhesive (meth)acrylic based polymeric component B, wherein the pre-adhesive (meth)acrylic based polymeric component B is unpolymerized; and a tackifier forming component; mixing the pre-adhesive mixture; and polymerizing the pre-adhesive mixture to form the adhesive composition.

### Embodiment 15

The method of embodiment 14, wherein the pre-adhesive mixture comprises: at least about 2 wt. % and not greater than 49 wt. % of the pre-adhesive (meth)acrylic based polymeric component A for a total weight of the pre-adhesive mixture; at least about 51 wt. % of the pre-adhesive (meth)acrylic based polymeric component B for a total weight of the pre-adhesive mixture; and at least about 0.1 wt. % and not greater than about 30 wt. % of the tackifier component for a total weight of the pre-adhesive mixture, wherein the pre-adhesive (meth)acrylic based polymeric component A is acidic and has a glass transition temperature (Tg) of at least about 40° C., and wherein the pre-adhesive (meth)acrylic based polymeric component B is basic and has a glass transition temperature (Tg) of not greater than about 20° C.

### Embodiment 16

The method of embodiment 14, wherein the pre-adhesive mixture comprises: at least about 2 wt. % and not greater than 49 wt. % of the pre-adhesive (meth)acrylic based polymeric component A for a total weight of the pre-adhesive mixture; at least about 51 wt. % of the pre-adhesive (meth)acrylic based polymeric component B for a total weight of the pre-adhesive mixture; and at least about 0.1 wt. % and not greater than about 30 wt. % of the tackifier component for a total weight of the pre-adhesive mixture, wherein the pre-adhesive (meth)acrylic based polymeric component A comprises a reaction product of polymerizable material comprising: at least about 40 wt. % and not greater than about 99 wt. % of a pre-adhesive monomer component a1 for a total weight of the pre-adhesive (meth)acrylic based polymeric component A, wherein the pre-adhesive monomer component a1 is an ethylenically unsaturated monomer, and at least about 0.1 wt. % and not greater than about 20 wt. % of a pre-adhesive monomer component a2 for a total weight of the pre-adhesive (meth)acrylic based polymeric component A, wherein the pre-adhesive monomer component a2 is an acidic monomer having an acidic group and an ethylenically unsaturated group, and wherein the pre-adhesive (meth)acrylic based polymeric component B is basic.

### Embodiment 17

The method of embodiment 14, wherein the pre-adhesive mixture comprises: at least about 2 wt. % and not greater than 49 wt. % of a pre-adhesive (meth)acrylic based polymeric component A for a total weight of the pre-adhesive mixture; at least about 51 wt. % of a pre-adhesive (meth)acrylic based polymeric component B for a total weight of the pre-adhesive mixture; and at least about 0.1 wt. % and not greater than about 30 wt. % of a tackifier component for a total weight of the pre-adhesive mixture, wherein the pre-adhesive (meth)acrylic based polymeric component A comprises a reaction product of polymerizable material comprising: at least about 40 wt. % and not greater than about 99 wt. % of a pre-adhesive monomer component a1 for a total weight of the pre-adhesive (meth)acrylic based polymeric component A, wherein the pre-adhesive monomer component a1 is an ethylenically unsaturated monomer, and at least about 0.1 wt. % and not greater than about 20 wt. % of a pre-adhesive monomer component a2 for a total weight of the pre-adhesive (meth)acrylic based polymeric component A, wherein the pre-adhesive monomer component a2 is an acidic monomer having an acidic group and an ethylenically unsaturated group, and wherein the pre-adhesive (meth)acrylic based polymeric component B comprises a reaction product of polymerizable material comprising: at least about 40 wt. % and not greater than about 99 wt. % of a pre-adhesive monomer component b1 for a total weight of the pre-adhesive (meth)acrylic based polymeric component B, wherein the pre-adhesive monomer component b1 is a C1-C24 acrylic ester, and at least about 1 wt. % and not greater than about 60 wt. % of a pre-adhesive monomer component b2 for a total weight of the pre-adhesive (meth)acrylic based polymeric component B, wherein the pre-adhesive monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 18

The method of any one of embodiments 15, 16, and 17, wherein the pre-adhesive (meth)acrylic based polymeric component A has a molecular weight of at least about 5,000 g/mol.

### Embodiment 19

The method of any one of embodiments 16 and 17, wherein the pre-adhesive (meth)acrylic based polymeric component A has a glass transition temperature (Tg) of at least about 40° C.

### Embodiment 20

The method of any one of embodiments 16 and 17, wherein the pre-adhesive (meth)acrylic based polymeric component B has a glass transition temperature (Tg) of not greater than about 20° C.

### Embodiment 21

The method of embodiment 15, wherein the pre-adhesive (meth)acrylic based polymeric component A comprises a reaction product of polymerizable material comprising: at least about 40 wt. % and not greater than about 99 wt. % of a pre-adhesive monomer component a1 for a total weight of the pre-adhesive (meth)acrylic based polymeric component A, wherein the pre-adhesive monomer component a1 is an ethylenically unsaturated monomer, and at least about 0.1 wt. % and not greater than about 20 wt. % of a pre-adhesive monomer component a2 for a total weight of the pre-adhesive (meth)acrylic based polymeric component A, wherein the pre-adhesive monomer component a2 is an acidic monomer having an acidic group and an ethylenically unsaturated group.

### Embodiment 22

The method of any one of embodiments 16, 17, and 21, wherein the monomer component a2 is an acid containing a (meth)acrylic monomer.

### Embodiment 23

The method of any one of embodiments 15, and 16, wherein the pre-adhesive (meth)acrylic based polymeric component B comprises a reaction product of polymerizable material comprising: at least about 40 wt. % and not greater than about 99 wt. % of a pre-adhesive monomer component b1 for a total weight of the pre-adhesive (meth)acrylic based polymeric component B, wherein the pre-adhesive monomer component b1 is a C1-C24 acrylic ester, and at least about 1 wt. % and not greater than about 60 wt. % of a pre-adhesive monomer component b2 for a total weight of the pre-adhesive (meth)acrylic based polymeric component B, wherein the pre-adhesive monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 24

The method of any one of embodiments 17, and 23, wherein the pre-adhesive (meth)acrylic based polymeric component A further comprises at least about 0.1 wt. % and not greater than about 60 wt. % of a pre-adhesive monomer component a3 for a total weight of the pre-adhesive (meth)acrylic based polymeric component A, wherein the pre-adhesive monomer component a3 is an ethylenically unsaturated functional monomer selected from hydroxyl containing (meth)acrylic ester or acrylamide.

### Embodiment 25

The method of any one of embodiments 17, and 23, wherein the pre-adhesive (meth)acrylic based polymeric component B further comprises at least about 0.1 wt. % and not greater than about 60 wt. % of a pre-adhesive monomer component b3 for a total weight of the pre-adhesive (meth)acrylic based polymeric component B, wherein the pre-adhesive monomer component b3 is an ethylenically unsaturated monomer and wherein the pre-adhesive monomer component b3 is different than both the pre-adhesive monomer component b1 and the pre-adhesive monomer component b2.

### Embodiment 26

The pre-adhesive mixture of embodiment 25, wherein the pre-adhesive monomer component b3 comprises: i. an acidic monomer having an acidic group and an ethylenically unsaturated group, ii. a hydroxy-containing acrylic ester monomer having a hydroxyl group and an ethylenically unsaturated group, iii. a nitrogen-containing monomer having a primary, secondary or a tertiary amino group or a nitrogen-containing monomer having a primary, secondary or tertiary amido group and an ethylenically unsaturated group, iv. a vinyl monomer, or v. a combination thereof.

### Embodiment 27

The method of embodiment 14, wherein the adhesive composition comprises: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A is acidic and has a glass transition temperature (Tg) of at least about 40° C., and wherein the (meth)acrylic based polymeric component B is basic and has a glass transition temperature (Tg) of not greater than about 20° C.

### Embodiment 28

The method of embodiment 14, wherein the adhesive composition comprises: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B is basic.

### Embodiment 29

The method of embodiment 14, wherein the adhesive composition comprises: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 30

The method of any one of embodiments 27, 28, and 29, wherein the (meth)acrylic based polymeric component A has a molecular weight of at least about 5,000 g/mol.

### Embodiment 31

The method of any one of embodiments 28, and 29, wherein the (meth)acrylic based polymeric component A has a glass transition temperature (Tg) of at least about 40° C.

### Embodiment 32

The method of any one of embodiments 28, and 29, wherein the (meth)acrylic based polymeric component B has a glass transition temperature (Tg) of not greater than about 20° C.

### Embodiment 33

The method of embodiment 27, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group.

### Embodiment 34

The method of any one of embodiments 27, and 28, wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 35

The method of any one of embodiments 28, and 29, wherein the (meth)acrylic based polymeric component A further comprises at least about 0.1 wt. % and not greater than about 60 wt. % of a monomer component a3 for a total weight of the (meth)acrylic based polymeric component A, wherein the monomer component a3 is an ethylenically unsaturated functional monomer selected from hydroxyl containing (meth)acrylic ester or acrylamide.

### Embodiment 36

The method of any one of embodiments 29, and 34, wherein the (meth)acrylic based polymeric component B further comprises at least about 0.1 wt. % and not greater than about 60 wt. % of a monomer component b3 for a total weight of the (meth)acrylic based polymeric component B, wherein the monomer component b3 is an ethylenically unsaturated monomer and wherein the monomer component b3 is different than both the monomer component b1 and the monomer component b2.

### Embodiment 37

The adhesive composition of embodiment 36, wherein the monomer component b3 comprises: i. an acidic monomer having an acidic group and an ethylenically unsaturated group, ii. a hydroxy-containing acrylic ester monomer having a hydroxyl group and an ethylenically unsaturated group, iii. a nitrogen-containing monomer having a primary, secondary or a tertiary amino group, or a nitrogen-containing monomer having a primary, secondary or tertiary amido group and an ethylenically unsaturated group, iv. a vinyl monomer, or v. a combination thereof.

### Embodiment 38

A monolayer foam tape comprising: a foam core comprising hollow microspheres within an adhesive composition, wherein the adhesive composition comprises: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A is acidic and has a glass transition temperature (Tg) of at least about 40° C., and wherein the (meth)acrylic based polymeric component B is basic and has a glass transition temperature (Tg) of not greater than about 20° C.

### Embodiment 39

A monolayer foam tape comprising: a foam core comprising hollow microspheres within an adhesive composition, wherein the adhesive composition comprises: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B is basic.

### Embodiment 40

A monolayer foam tape comprising: a foam core comprising hollow microspheres within an adhesive composition, wherein the adhesive composition comprises: at least about 2 wt. % and not greater than 49 wt. % of a (meth)acrylic based polymeric component A for a total weight of the adhesive composition; at least about 51 wt. % of a (meth)acrylic based polymeric component B for a total weight of the adhesive composition; and at least about 0.1 wt. % and not greater than about 30 wt. % of a tackifier component for a total weight of the adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b 1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 41

The monolayer foam tape of any one of embodiments 38, 39, and 40, wherein the monolayer foam tape has a thickness of at least about 0.125 mm.

### Embodiment 42

The monolayer foam tape of any one of embodiments 38, 39, and 40, wherein the monolayer foam tape has a thickness of not greater than about 0.25 mm.

### Embodiment 43

The monolayer foam tape of any one of embodiments 38, 39, and 40, wherein the hollow spheres comprise glass beads, polymeric microspheres or a combination thereof.

### Embodiment 44

The monolayer foam tape of any one of embodiments 38, 39, and 40, wherein the (meth)acrylic based polymeric component A has a molecular weight of at least about 5,000 g/mol.

### Embodiment 45

The monolayer foam tape of any one of embodiments 39, and 40, wherein the (meth)acrylic based polymeric component A has a glass transition temperature (Tg) of at least about 40° C.

### Embodiment 46

The monolayer foam tape of any one of embodiments 39, and 40, wherein the (meth)acrylic based polymeric component B has a glass transition temperature (Tg) of not greater than about 20° C.

### Embodiment 47

The monolayer foam tape of embodiment 38, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group.

### Embodiment 48

The monolayer foam tape of any one of embodiments 39, 40, and 47, wherein the monomer component a2 is an acid containing a (meth)acrylic monomer.

### Embodiment 49

The monolayer foam tape of any one of embodiments 38, and 39, wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 50

The monolayer foam tape of any one of embodiments 39, 40, and 47, wherein the (meth)acrylic based polymeric component A further comprises at least about 0.1 wt. % and not greater than about 60 wt. % of a monomer component a3 for a total weight of the (meth)acrylic based polymeric component A, wherein the monomer component a3 is an ethylenically unsaturated functional monomer selected from hydroxyl containing (meth)acrylic ester or acrylamide.

### Embodiment 51

The monolayer foam tape of any one of embodiments 40, and 49, wherein the (meth)acrylic based polymeric component B further comprises at least about 0.1 wt. % and not greater than about 60 wt. % of a monomer component b3 for a total weight of the (meth)acrylic based polymeric component B, wherein the monomer component b3 is an ethylenically unsaturated monomer and wherein the monomer component b3 is different than both the monomer component b1 and the monomer component b2.

### Embodiment 52

The monolayer foam tape of embodiment 51, wherein the monomer component b3 comprises: i. an acidic monomer having an acidic group and an ethylenically unsaturated group, ii. a hydroxy-containing acrylic ester monomer having a hydroxyl group and an ethylenically unsaturated group, iii. a nitrogen-containing monomer having a primary, secondary or a tertiary amino group, or a nitrogen-containing monomer having a primary, secondary or tertiary amido group and an ethylenically unsaturated group, iv. a vinyl monomer, or v. a combination thereof.

### Embodiment 53

The monolayer foam tape of any one of embodiments 38, 39, and 40, wherein the tackifier component comprises C5, C9, C5/C9, dicyclopentadiene, terpene, or their hydrogenated resins, or combinations thereof.

### Embodiment 54

A foam tape comprising: a foam core comprising hollow microspheres within a foam material, and a first adhesive layer overlying a first surface of the foam core, wherein the first adhesive layer comprises a first adhesive composition comprising: at least about 2 wt. % and not greater than 49 wt. % of a (meth)acrylic based polymeric component A for a total weight of the first adhesive composition; at least about 51 wt. % of a (meth)acrylic based polymeric component B for a total weight of the first adhesive composition; and at least about 0.1 wt. % and not greater than about 30 wt. % of a tackifier component for a total weight of the first adhesive composition, wherein the (meth)acrylic based polymeric component A is acidic and has a glass transition temperature (Tg) of at least about 40° C., and wherein the (meth)acrylic based polymeric component B is basic and has a glass transition temperature (Tg) of not greater than about 20° C.

### Embodiment 55

A foam tape comprising: a foam core comprising hollow microspheres within a foam material, and a first adhesive layer overlying a first surface of the foam core, wherein the first adhesive layer comprises a first adhesive composition comprising: at least about 2 wt. % and not greater than 49 wt. % of a (meth)acrylic based polymeric component A for a total weight of the first adhesive composition; at least about 51 wt. % of a (meth)acrylic based polymeric component B for a total weight of the first adhesive composition; and at least about 0.1 wt. % and not greater than about 30 wt. % of a tackifier component for a total weight of the first adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B is basic.

### Embodiment 56

A foam tape comprising: a foam core comprising hollow microspheres within a foam material, and a first adhesive layer overlying a first surface of the foam core, wherein the first adhesive layer comprises a first adhesive composition comprising: at least about 2 wt. % and not greater than 49 wt. % of a (meth)acrylic based polymeric component A for a total weight of the first adhesive composition; at least about 51 wt. % of a (meth)acrylic based polymeric component B for a total weight of the first adhesive composition; and at least about 0.1 wt. % and not greater than about 30 wt. % of a tackifier component for a total weight of the first adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 57

The foam tape of any one of embodiments 54, 55, and 56, wherein the first adhesive layer has a thickness of at least about 0.125 mm.

### Embodiment 58

The foam tape of any one of embodiments 54, 55, and 56, wherein the first adhesive layer has a thickness of not greater than about 0.25 mm.

### Embodiment 59

The foam tape of any one of embodiments 54, 55, and 56, wherein the foam material comprises an acrylic material, a polyurethane material, a polyethylene material, a PVC material or combinations thereof.

### Embodiment 60

The foam tape of any one of embodiments 54, 55, and 56, wherein the foam material comprises an acrylic foam or a polyurethane foam.

### Embodiment 61

The foam tape of any one of embodiments 54, 55, and 56, wherein the hollow spheres comprise glass beads, polymeric microspheres or a combination thereof.

### Embodiment 62

The foam tape of any one of embodiments 54, 55, and 56, wherein the (meth)acrylic based polymeric component A has a molecular weight of at least about 5,000 g/mol.

### Embodiment 63

The foam tape of any one of embodiments 55, and 56, wherein the (meth)acrylic based polymeric component A has a glass transition temperature (Tg) of at least about 40° C.

### Embodiment 64

The foam tape of any one of embodiments 55, and 56, wherein the (meth)acrylic based polymeric component B has a glass transition temperature (Tg) of not greater than about 20° C.

### Embodiment 65

The foam tape of embodiment 54, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group.

### Embodiment 66

The foam tape of any one of embodiments 55, 56, and 65, wherein the monomer component a2 is an acid containing a (meth)acrylic monomer.

### Embodiment 67

The foam tape of any one of embodiments 54, and 55, wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 68

The foam tape of any one of embodiments 55, 56, and 65, wherein the (meth)acrylic based polymeric component A further comprises at least about 0.1 wt. % and not greater than about 60 wt. % of a monomer component a3 for a total weight of the (meth)acrylic based polymeric component A, wherein the monomer component a3 is an ethylenically unsaturated functional monomer selected from hydroxyl containing (meth)acrylic ester or acrylamide.

### Embodiment 69

The foam tape of any one of embodiments 56, and 67, wherein the (meth)acrylic based polymeric component B further comprises at least about 0.1 wt. % and not greater than about 60 wt. % of a monomer component b3 for a total weight of the (meth)acrylic based polymeric component B, wherein the monomer component b3 is an ethylenically unsaturated monomer and wherein the monomer component b3 is different than both the monomer component b1 and the monomer component b2.

### Embodiment 70

The foam tape of embodiment 69, wherein the monomer component b3 comprises: i. an acidic monomer having an acidic group and an ethylenically unsaturated group, ii. a hydroxy-containing acrylic ester monomer having a hydroxyl group and an ethylenically unsaturated group, iii. a nitrogen-containing monomer having a primary, secondary or a tertiary amino group, or a nitrogen-containing monomer having a primary, secondary or tertiary amido group, and an ethylenically unsaturated group, iv. a vinyl monomer, or v. a combination thereof.

### Embodiment 71

The foam tape of any one of embodiments 54, 55, and 56, wherein the tackifier component comprises C5, C9, C5/C9, dicyclopentadiene, terpene, or their hydrogenated resins, or combinations thereof.

### Embodiment 72

The foam tape of any one of embodiments 54, 55, and 56, wherein the foam tape further comprises a second adhesive layer overlying a second surface of the foam core, wherein the second adhesive layer comprises a second adhesive composition.

### Embodiment 73

The foam tape of embodiment 72, wherein the second adhesive composition comprising: at least about 2 wt. % and not greater than 49 wt. % of a (meth)acrylic based polymeric component A for a total weight of the second adhesive composition; at least about 51 wt. % of a (meth)acrylic based polymeric component B for a total weight of the second adhesive composition; and at least about 0.1 wt. % and not greater than about 30 wt. % of a tackifier component for a total weight of the second adhesive composition, wherein the (meth)acrylic based polymeric component A is acidic and has a glass transition temperature (Tg) of at least about 40° C., and wherein the (meth)acrylic based polymeric component B is basic and has a glass transition temperature (Tg) of not greater than about 20° C.

### Embodiment 74

The foam tape of embodiment 72, wherein the second adhesive composition comprising: at least about 2 wt. % and not greater than 49 wt. % of a (meth)acrylic based polymeric component A for a total weight of the second adhesive composition; at least about 51 wt. % of a (meth)acrylic based polymeric component B for a total weight of the second adhesive composition; and at least about 0.1 wt. % and not greater than about 30 wt. % of a tackifier component for a total weight of the second adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B is basic.

### Embodiment 75

The foam tape of embodiment 72, wherein the second adhesive composition comprising: at least about 2 wt. % and not greater than 49 wt. % of a (meth)acrylic based polymeric component A for a total weight of the second adhesive composition; at least about 51 wt. % of a (meth)acrylic based polymeric component B for a total weight of the second adhesive composition; and at least about 0.1 wt. % and not greater than about 30 wt. % of a tackifier component for a total weight of the second adhesive composition, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 76

The foam tape of any one of embodiments 73, 74, and 75, wherein the (meth)acrylic based polymeric component A has a molecular weight of at least about 5,000 g/mol.

### Embodiment 77

The foam tape of any one of embodiments 74, and 75, wherein the (meth)acrylic based polymeric component A has a glass transition temperature (Tg) of at least about 40° C.

### Embodiment 78

The foam tape of any one of embodiments 74, and 75, wherein the (meth)acrylic based polymeric component B has a glass transition temperature (Tg) of not greater than about 20° C.

### Embodiment 79

The foam tape of embodiment 73, wherein the (meth)acrylic based polymeric component A comprises a reaction product of polymerizable material comprising: at least about 40 wt. % and not greater than about 99 wt. % of a monomer component a1 for a total weight of the (meth)acrylic based polymeric component A, wherein the monomer component a1 is an ethylenically unsaturated monomer, and at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group.

### Embodiment 80

The foam tape of any one of embodiments 74, 75, and 79, wherein the monomer component a2 is an acid containing a (meth)acrylic monomer.

### Embodiment 81

The foam tape of any one of embodiments 73, and 74, wherein the (meth)acrylic based polymeric component B comprises a reaction product of polymerizable material comprising: at least about 40 wt. % and not greater than about 99 wt. % of a monomer component b1 for a total weight of the (meth)acrylic based polymeric component B, wherein the monomer component b1 is a C1-C24 acrylic ester, and at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

### Embodiment 82

The foam tape of any one of embodiments 74, and 75, wherein the (meth)acrylic based polymeric component A further comprises at least about 0.1 wt. % and not greater than about 60 wt. % of a monomer component a3 for a total weight of the (meth)acrylic based polymeric component A, wherein the monomer component a3 is an ethylenically unsaturated functional monomer selected from hydroxyl containing (meth)acrylic ester or acrylamide.

### Embodiment 83

The foam tape of embodiment 81, wherein the (meth)acrylic based polymeric component B further comprises at least about 0.1 wt. % and not greater than about 60 wt. % of a monomer component b3 for a total weight of the (meth)acrylic based polymeric component B, wherein the monomer component b3 is an ethylenically unsaturated monomer and wherein the monomer component b3 is different than both the monomer component b 1 and the monomer component b2.

### Embodiment 84

The foam tape of embodiment 83, wherein the monomer component b3 comprises: i. an acidic monomer having an acidic group and an ethylenically unsaturated group, ii. a hydroxy-containing acrylic ester monomer having a hydroxyl group and an ethylenically unsaturated group, iii. a nitrogen-containing monomer having a primary, secondary or a tertiary amino group, or a nitrogen-containing monomer having a primary, secondary or tertiary amido group and a ethylenically unsaturated group, iv. a vinyl monomer, or v. a combination thereof.

### Embodiment 85

The foam tape of any one of embodiments 73, 74, and 75, wherein the tackifier component comprises C5, C9, C5/C9, dicyclopentadiene, terpene, or their hydrogenated resins, or combinations thereof.

### EXAMPLES

The concepts described herein will be further described in the following Examples, which do not limit the scope of the invention described in the claims.

Testing Methods

The following test methods have been used to evaluate adhesives of the invention. All percentages, parts and ratios within the specification, including the examples, and the claims are by weight unless specifically stated otherwise.

Test Method A1:

A strip of anodized aluminum (dimensions 19 mm×200 mm×0.125 mm) is positioned on the non-testing adhesive face of a tape sample 10 mm wide and at least 100 mm long. Pressure is applied to the aluminum by rolling with a 6.8 kg roller. The opposite face (testing side) of the sample is then firmly bonded to either a polypropylene or polypropylene-ethylene propylene diene terpolymer panel pre-cleaned with either heptane or isopropyl alcohol. After being conditioned for 24 hours at room temperature and 50% relative humidity, the sample is removed by pulling the aluminum strip at 90° to the adhesive surface at a speed of 30.5 cm/minute. The test value is reported as the force needed to remove the tape from the plastic panel (adhesive delamination), or cohesively split the tape. Foam split (FS) is the most desirable failure mode as it indicates adhesion to the substrate is stronger than the internal strength of the foam layer.

Test Method B1:

The non-testing adhesive face of a 2.54 cm×2.54 cm piece of foam tape is positioned onto the center of the 3.0 cm×3.0 cm square portion of an aluminum fixture shaped in a 90° angle and rolled by a 6.8 kg weight. The other side (testing side) of the foam tape is applied onto the center of a 7.62 cm×5.08 cm polypropylene or polypropylene-ethylene propylene diene terpolymer panel pre-cleaned with either heptane or isopropyl alcohol, and rolled again with a 6.8 kg weight. After being conditioned for 24 hours at room temperature and 50% relative humidity, the assembly is affixed by the plastic panel and a 1.5 kg weight is hung from the other arm of the 90° angle aluminum fixture. The time at which the weight falls off is recorded in hours. If no failure occurs after 10,000 minutes, the test is discontinued.

Test Method B2:

The test conditions are similar to B1, except that the assembly is placed inside an 80° C. air circulating oven, and a 500 g weight is hung from the aluminum fixture.

Test Method C:

The weight average molecular weight (Mw) and the polydispersity index (PDI) of the samples are determined via gel permeation chromatography (GPC). A Shimadzu Prominence LC-20AD system with a Shimadzu RID-20A refractive index detector was used. The GPC was equipped with a set of oligomer columns, which were calibrated with 10 narrow polydispersity polystyrene standards to give a linear calibration range from 200 to 2×107 g mol−1. Tetrahydraforuan (THF, flow rate of 1 mL min−1) was used as the effluent at 40° C. For each measurement, 30 mg of polymer was dissolved in 4 mL of THF, and filtered through a 200 μm nylon filter prior to injection.

Raw Materials:

All chemicals were used as received without further purification or treatment.

| Raw materials | Manufacturer |
|---|---|
| 2-EHA, 2-ethylhexyl acrylate | Acros Organics |
| AA, acrylic acid | Sigma Aldrich |
| MAA, methacrylic acid | Sigma Aldrich |
| AAm, acrylamide | Sigma Aldrich |
| MAAm, methacrylamide | Sigma Aldrich |
| HEAA, 2-hydroxyethyl acrylamide | Sigma-Aldrich |
| NVP, N-vinylpyrrolidone | Sigma-Aldrich |
| IBOA, isobornyl acrylate | Sigma-Aldrich |
| IBOMA, isobornyl methacrylate | Sigma-Aldrich |
| 2-HEA, 2-hydroxyethyl acrylate | Sigma-Aldrich |
| HEMA, 2-hydroxyethyl methacrylate | Sigma-Aldrich |
| Irgacure 2022 | BASF |
| Irgacure 819 | BASF |
| IOTG, isooctyl thioglycolate | Sigma-Aldrich |
| HDDA, 1,6-hexanediol-diacrylate | Sigma-Aldrich |
| R1094, Regalrez 1094, hydrogenated | Eastman Chemical |
| hydrocarbon tackifier | |
| POVAL 100-88 | Kuraray |

The adhesive is coated and cured either on a 50 micron PET film, or on a 0.9 mm proprietary acrylic foam core made from approximately 10% wt of acrylic acid, 90% wt of 2-ethylhexyl acrylate, microspheres and other commonly used materials.

### Example 1: Samples S1-S4

Sample adhesive compositions S1-S4 were formed according to embodiments described herein. The compositions of sample adhesives S1-S4 are summarized in Table 1 below.

TABLE 1
Sample Adhesive Composition

| | pphr in | | | | | |
|---|---|---|---|---|---|---|
| | final | | | | | |
| Component | syrup | | S1 | S2 | S3 | S4 |
| Component A | 10 | | A1 | A2 | A3 | A1 |
| Component B | 64.45 | 2-EHA | 91 | 91 | 91 | 91 |
| | | NVP | 6 | 6 | 6 | 6 |
| | | 2-HEA | 2 | 2 | 2 | 3 |
| | | HEAA | 1 | 1 | 1 | 0 |
| Tackifier | 10 | | R1094 | R1094 | R1094 | R1094 |

| | |
|---|---|
| IBOA | 15 |
| Irgacure 2022 | 0.4 |
| HDDA | 0.15 |

The acidic polymeric component A used in adhesive compositions S1-S4 were synthesized via suspension polymerization of isobornyl acrylate/methacrylate with different acidic co-monomers. The typical procedure was as follows: 400 mL of distilled water was added to a 1 L glass vessel and sparged for with nitrogen gas for 1 hour, and then heated to 65° C. At the same time, IBOA (75 g), IBOMA (22 g), MAA (3 g), IOTG (0.7 g) and AIBN (1.0 g) were combined in a round bottom flask and purged with nitrogen gas for 45 minutes. Once the water temperature reached 65° C., POVAL 100-88 (5 g of 5 wt. % solution in distilled water) was added to the water and stirred at 700 rpm. The deoxygenated monomer mixture was then added to the reactor until rigorous agitation. The reactor contents were then heated to 75° C. and held at that temperature for 5.5 hours. 10 mL of 10% potassium hydroxide solution was added to the mixture and held at 75 C for another 2 hours. The mixture was cooled and the contents isolated by filtration and repeated washes with distilled water. The filtered polymeric component A was dried in a vacuum oven set at 85° C. for 24 hours to remove any residual water. The properties of sample acidic polymeric component A1-A4 are shown in Table 2.

TABLE 2
Properties of sample acidic polymeric component A

| Acidic | Acidic | | |
|---|---|---|---|
| Component A | co-monomers | M_{w} (g/mol) | PDI |
| A1 | MAA, 3 wt. % | 42000 | 2.1 |
| A2 | MAA, 6 wt. % | 43000 | 2.1 |
| A3 | MAA, 3 wt. %, MAAm, 3 wt. % | 37000 | 2.1 |

Component B in sample adhesive composition S1-S4 were made by copolymerizing a mixture of acrylic esters and basic monomers under UV-initiated radical photopolymerization as per the weight percent composition given in Table 1. On a 400 g basis, Irgacure 819 (0.1 g) was dissolved in the above monomer mixture, which was then purged with nitrogen gas for 1 hour prior to UV exposure with a 365 nm, 5 mW/cm2 UV light. The polymerization was carried out until a temperature increase of 15-20° C. was observed. The resulting basic polymeric component B had a viscosity of approximately 10000 cP.

The sample adhesive composition S1 was formed by first combining the relevant acidic polymeric component A, basic polymeric component B, tackifier, IBOA, Irgacure 2022, and HDDA in the amounts as indicated Table 1. The different components were mixed at room temperature until the acidic and basic polymeric components were fully dissolved to make syrup S1. The syrup was then coated onto the aforementioned 0.9 mm acrylic foam core or onto a 50 micron PET film, and cured under 365 nm, 5 mW/cm2 UV light for 8 minutes to form an adhesive coating with an approximate thickness of 100 microns.

For sample adhesive compositions S2, S3, and S4 were made in the same method as sample adhesive composition S1, except that the relevant acidic polymeric components A and basic polymeric components B were substituted as specified in Table 1.

### Example 2: Comparative Samples C1-C3

Comparative sample adhesive compositions C1-C3 were prepared to illustrate the unique properties of the described adhesive containing acidic and basic components. The composition of the comparative sample adhesives C1-C3 are summarized in Table 3 below.

TABLE 3
Comparative Adhesive Composition

| | pphr in final | | | | |
|---|---|---|---|---|---|
| Component | syrup | | C1 | C2 | C3 |
| Component N | 10 | | N1 | N1 | N2 |
| Component B | 64.45 | 2-EHA | 91 | 91 | 91 |
| | | NVP | 6 | 6 | 6 |
| | | 2-HEA | 2 | 3 | 2 |
| | | HEAA | 1 | 0 | 1 |
| Tackifier | 10 | | R1094 | R1094 | R1094 |
| IBOA | 15 | | | | |
| Irgacure 2022 | 0.4 | | | | |
| HDDA | 0.15 | | | | |

Component N in the comparative adhesive compositions was prepared via a similar suspension polymerization process as used to prepare acidic polymeric component A. However, the acidic co-monomers were substituted for other polar comonomers, such as hydroxyl containing monomers, or a mixture of neutral hydroxyl containing monomers and basic nitrogen containing monomers. The properties of polymeric component N are summarized in Table 4 below.

TABLE 4
Properties of sample component N

| Component N | Polar co-monomers | M_{w} (g/mol) | PDI |
|---|---|---|---|
| N1 | HEMA, 6 wt. % | 43000 | 2.1 |
| N2 | HEMA, 2 wt. %, MAAm, 2 wt. % | 41000 | 2.1 |

Component B in comparative adhesive compositions C1-C3 were prepared as per the instructions given for sample adhesive S1. The comparative adhesive compositions C1-C3 were made by combining component N, basic polymeric component B, tackifier, IBOA, Irgacure 2022, and HDDA in the amounts as indicated in Table 3. The different components were mixed at room temperature until component N was fully dissolved to make syrups C1-C3. The syrup was then coated onto the aforementioned 0.9 mm acrylic foam core or onto a 50 micron PET film, and cured under 365 nm, 5 mW/cm2 UV light for 8 minutes to form an adhesive coating with an approximate thickness of 100 microns.

The adhesion of our sample adhesives to low surface energy substrates such as polypropylene and polypropylene/polyethylene copolymers was evaluated using Test Method A1. The peel strength of sample adhesives S1-S4 and comparative adhesives C1-C3 are summarized in Table 5 below. The abbreviation FS stands for foam split.

TABLE 5
Peel strength of sample adhesive compositions S1-S4
and comparative adhesive composition C1-C3.

| | Test A1 (N/cm) |
|---|---|
| S1 | 39.5, FS |
| S2 | 39.0, FS |
| S3 | 39.0, FS |
| S4 | 38.2, FS |
| C1 | 38.9, FS |
| C2 | 39.5, FS |
| C3 | 39.4, FS |

Test Method A1 is a 90° peel test performed at a fixed displacement. This is a standard industry test which can readily separate good and bad adhesion performance. Our inventive adhesive samples and comparative adhesive samples were all formulated to have good adhesion to low surface energy substrates, and as such all behave similarly in the industry standard fixed displacement speed test.

High adhesion and cohesion under strenuous conditions can be better measured under a more rigorous fixed load 90° peel test as described in Test Method B1 and B2. In these tests, we apply a fixed load and observe the time to failure, which places much a larger stress on the adhesive and is a better indicator of high adhesion and high cohesion in demanding applications. The performance of adhesive samples S1-S4 and comparative adhesives C1-C3 in Tests B1 and B2 are summarized in Table 6 below.

TABLE 6
Performance of S1-S4 and comparative adhesive composition
C1-C3 under fixed load 90° peel test.

| | |
|---|---|
| Test B1 | Test B2 |

| | | | | |
|---|---|---|---|---|
| S1 | >168 | hrs | 48 | hrs |
| S2 | >168 | hrs | 114 | hrs |
| S3 | >168 | hrs | >168 | hrs |
| S4 | >168 | hrs | 65 | hrs |
| C1 | >168 | hrs | 7 | hrs |
| C2 | >168 | hrs | 7 | hrs |
| C3 | 132 | hrs | 3 | hrs |

The data clearly shows that the adhesives of the present invention containing an acidic and basic component have superior adhesion and cohesion strength, especially when tested at high temperatures as per Test B2. The comparative adhesives fractured and failed rapidly, whereas the inventive adhesives had much better holding power under these strenuous conditions.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An adhesive composition comprising:
at least about 2 wt. % and not greater than 49 wt. % of a (meth)acrylic based polymeric component A for a total weight of the adhesive composition;
at least about 51 wt. % of a (meth)acrylic based polymeric component B for a total weight of the adhesive composition; and
at least about 0.1 wt. % and not greater than about 30 wt. % of a tackifier component for a total weight of the adhesive composition,
wherein the (meth)acrylic based polymeric component A is acidic and has a glass transition temperature (Tg) of at least about 40° C., and
wherein the (meth)acrylic based polymeric component B is basic and has a glass transition temperature (Tg) of not greater than about 20° C.

2. The adhesive composition of claim 1, wherein the (meth)acrylic based polymeric component A has a molecular weight of at least about 5,000 g/mol.

3. The adhesive composition of claim 1, wherein the (meth)acrylic based polymeric component A comprises a reaction product of polymerizable material comprising:
at least about 40 wt. % and not greater than about 99 wt. % of a monomer component a1 for a total weight of the (meth)acrylic based polymeric component A, wherein the monomer component a1 is an ethylenically unsaturated monomer, and
at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group.

4. The adhesive composition of claim 3, wherein the monomer component a2 is an acid containing (meth)acrylic monomer.

5. The adhesive composition of claim 1, wherein the (meth)acrylic based polymeric component B comprises a reaction product of polymerizable material comprising:
at least about 40 wt. % and not greater than about 99 wt. % of a monomer component b1 for a total weight of the (meth)acrylic based polymeric component B, wherein the monomer component b1 is a C1-C24 acrylic ester, and
at least about 1 wt. % and not greater than about 60 wt. % of a monomer component b2 for a total weight of the (meth)acrylic based polymeric component B, wherein the monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

6. The adhesive composition of claim 3, wherein the (meth)acrylic based polymeric component A further comprises at least about 0.1 wt. % and not greater than about 60 wt. % of a monomer component a3 for a total weight of the (meth)acrylic based polymeric component A, wherein the monomer component a3 is an ethylenically unsaturated functional monomer selected from hydroxyl containing (meth)acrylic ester or acrylamide.

7. The adhesive composition of claim 5, wherein the (meth)acrylic based polymeric component B further comprises at least about 0.1 wt. % and not greater than about 60 wt. % of a monomer component b3 for a total weight of the (meth)acrylic based polymeric component B, wherein the monomer component b3 is an ethylenically unsaturated monomer and wherein the monomer component b3 is different than both the monomer component b 1 and the monomer component b2.

8. The adhesive composition of claim 7, wherein the monomer component b3 comprises:
i. an acidic monomer having an acidic group and an ethylenically unsaturated group,
ii. a hydroxy-containing acrylic ester monomer having a hydroxyl group and an ethylenically unsaturated group,
iii. a nitrogen-containing monomer having a primary, secondary or a tertiary amino group or, a nitrogen-containing monomer having a primary, secondary or tertiary amido group, and an ethylenically unsaturated group,
iv. a vinyl monomer, or
v. a combination thereof.

9. The adhesive composition of claim 1, wherein the tackifier component comprises C5, C9, C5/C9, dicyclopentadiene, terpene, or their hydrogenated resins, or combinations thereof.

10. An adhesive composition comprising:
at least about 2 wt. % and not greater than 49 wt. % of a (meth)acrylic based polymeric component A for a total weight of the adhesive composition;
at least about 51 wt. % of a (meth)acrylic based polymeric component B for a total weight of the adhesive composition; and
at least about 0.1 wt. % and not greater than about 30 wt. % of a tackifier component for a total weight of the adhesive composition,
wherein the (meth)acrylic based polymeric component A comprises a reaction product of polymerizable material comprising:
at least about 40 wt. % and not greater than about 99 wt. % of a monomer component a1 for a total weight of the (meth)acrylic based polymeric component A, wherein the monomer component a1 is an ethylenically unsaturated monomer, and
at least about 0.1 wt. % and not greater than about 20 wt. % of a monomer component a2 for a total weight of the (meth)acrylic based polymeric component A, wherein the monomer component a2 is an acidic monomer having an acidic group and an ethylenically unsaturated group, and
wherein the (meth)acrylic based polymeric component B is basic.

11. The adhesive composition of claim 10, wherein the (meth)acrylic based polymeric component A has a molecular weight of at least about 5,000 g/mol.

12. The adhesive composition of claim 10, wherein the monomer component a2 is an acid containing (meth)acrylic monomer.

13. The adhesive composition of claim 10, wherein the (meth)acrylic based polymeric component B comprises a reaction product of polymerizable material comprising:
at least about 40 wt. % and not greater than about 99 wt. % of a monomer component b1 for a total weight of the (meth)acrylic based polymeric component B, wherein the monomer component b1 is a C1-C24 acrylic ester, and

14. The adhesive composition of claim 10, wherein the (meth)acrylic based polymeric component A further comprises at least about 0.1 wt. % and not greater than about 60 wt. % of a monomer component a3 for a total weight of the (meth)acrylic based polymeric component A, wherein the monomer component a3 is an ethylenically unsaturated functional monomer selected from hydroxyl containing (meth)acrylic ester or acrylamide.

15. A method of forming an adhesive composition, wherein the method comprises
providing a pre-adhesive mixture comprising:
a pre-adhesive (meth)acrylic based polymeric component A, wherein the pre-adhesive (meth)acrylic based polymeric component A is fully polymerized;
a pre-adhesive (meth)acrylic based polymeric component B, wherein the pre-adhesive (meth)acrylic based polymeric component B is unpolymerized; and
a tackifier forming component;
mixing the pre-adhesive mixture; and
polymerizing the pre-adhesive mixture to form the adhesive composition.

16. The method of claim 15, wherein the pre-adhesive mixture comprises:
at least about 2 wt. % and not greater than 49 wt. % of the pre-adhesive (meth)acrylic based polymeric component A for a total weight of the pre-adhesive mixture;
at least about 51 wt. % of the pre-adhesive (meth)acrylic based polymeric component B for a total weight of the pre-adhesive mixture; and
at least about 0.1 wt. % and not greater than about 30 wt. % of the tackifier component for a total weight of the pre-adhesive mixture,
wherein the pre-adhesive (meth)acrylic based polymeric component A is acidic and has a glass transition temperature (Tg) of at least about 40° C., and
wherein the pre-adhesive (meth)acrylic based polymeric component B is basic and has a glass transition temperature (Tg) of not greater than about 20° C.

17. The method of claim 15, wherein the pre-adhesive mixture comprises:
at least about 2 wt. % and not greater than 49 wt. % of the pre-adhesive (meth)acrylic based polymeric component A for a total weight of the pre-adhesive mixture;
at least about 51 wt. % of the pre-adhesive (meth)acrylic based polymeric component B for a total weight of the pre-adhesive mixture; and
at least about 0.1 wt. % and not greater than about 30 wt. % of the tackifier component for a total weight of the pre-adhesive mixture,
wherein the pre-adhesive (meth)acrylic based polymeric component A comprises a reaction product of polymerizable material comprising:
at least about 40 wt. % and not greater than about 99 wt. % of a pre-adhesive monomer component a1 for a total weight of the pre-adhesive (meth)acrylic based polymeric component A, wherein the pre-adhesive monomer component a1 is an ethylenically unsaturated monomer, and
at least about 0.1 wt. % and not greater than about 20 wt. % of a pre-adhesive monomer component a2 for a total weight of the pre-adhesive (meth)acrylic based polymeric component A, wherein the pre-adhesive monomer component a2 is an acidic monomer having an acidic group and an ethylenically unsaturated group, and
wherein the pre-adhesive (meth)acrylic based polymeric component B is basic.

18. The method of claim 14, wherein the pre-adhesive (meth)acrylic based polymeric component A has a molecular weight of at least about 5,000 g/mol.

19. The method of claim 14, wherein the pre-adhesive (meth)acrylic based polymeric component B comprises a reaction product of polymerizable material comprising:
at least about 40 wt. % and not greater than about 99 wt. % of a pre-adhesive monomer component b1 for a total weight of the pre-adhesive (meth)acrylic based polymeric component B, wherein the pre-adhesive monomer component b1 is a C1-C24 acrylic ester, and
at least about 1 wt. % and not greater than about 60 wt. % of a pre-adhesive monomer component b2 for a total weight of the pre-adhesive (meth)acrylic based polymeric component B, wherein the pre-adhesive monomer component b2 is an ethylenically unsaturated functional monomer selected from hydroxyl containing (meth)acrylic monomer, a nitrogen-containing monomer having a primary, secondary or tertiary amino group, or a nitrogen-containing monomer having a primary, secondary or tertiary amido group.

20. The method of claim 19, wherein the pre-adhesive (meth)acrylic based polymeric component B further comprises at least about 0.1 wt. % and not greater than about 60 wt. % of a pre-adhesive monomer component b3 for a total weight of the pre-adhesive (meth)acrylic based polymeric component B, wherein the pre-adhesive monomer component b3 is an ethylenically unsaturated monomer and wherein the pre-adhesive monomer component b3 is different than both the pre-adhesive monomer component b1 and the pre-adhesive monomer component b2.
